(19) United States
(12) Patent Application Publication
(10) Pub. No.: US 2021/0240159 A1
(43) Pub. Date: Aug. 5, 2021

(54) Moment-Based Representation for Interoperable Analysis

(71) Applicant: Intact Solutions, Inc., Madison, WI (US)

(72) Inventors: Andrew Taber, Madison, WI (US); Goldy Kumar, Madison, WI (US); Michael Freytag, Madison, WI (US); Vadim Shapiro, Madison, WI (US)

(73) Assignee: Intact Solutions, Inc., Madison, WI (US)

(21) Appl. No.: 17/204,006

(22) Filed: Mar. 17, 2021

Related U.S. Application Data
(63) Continuation-in-part of application No. 16/247,108, filed on Jan. 14, 2019.
(60) Provisional application No. 62/621,565, filed on Jan. 24, 2018.
(60) Provisional application No. 62/682,558, filed on Jun. 8, 2018.
(60) Provisional application No. 62/992,565, filed on Mar. 20, 2020.

(51) Int. Cl. G05B 19/4099; G06F 17/11; G06F 17/16; B33Y 50/00; B29C 64/386

(52) U.S. Cl. CPC G05B 19/4099; G06F 17/11; G06F 17/16; G05B 2219/35151; B29C 64/386; G05B 2219/35107; G05B 2219/35134; B33Y 50/00

(57) ABSTRACT

Methods and system for computing integrals over geometric domains using moment-base representations for interoperability are disclosed. A first computing device may receive data for geometric and field representations of an object, the geometric representation specifying a geometric domain of the object, and the field representation specifying a spatially varying physical quantity. The first computing device may integrate a predetermined set of basis functions over the geometric domain multiplied by a field to derive a moment-vector for the object, the moment-vector encapsulating an analytic formulation of the geometric domain that is independent of the geometric and field representations. The first computing device may computationally generate quadrature rules for integrating an arbitrary function by applying moment-fitting to the moment-vector. The quadrature rules may be provided to a second computing device, which may integrate the arbitrary function over the geometric domain by applying the quadrature rules, independently of the geometric and field representations.

### CROSS-REFERENCE TO RELATED APPLICATIONS

This application is a continuation-in-part of U.S. patent application Ser. No. 16/247,108, filed Jan. 14, 2019, which claims priority under 35 U.S.C. § 119(e) to U.S. Provisional Patent Application Ser. No. 62/621,565, filed on Jan. 24, 2018, and to U.S. Provisional Patent Application Ser. No. 62/682,558, filed on Jun. 8, 2018. This application also claims priority under 35 U.S.C. § 119(e) to U.S. Provisional Patent Application Ser. No. 62/992,565, filed on Mar. 20, 2020. All of the aforementioned applications are incorporated herein by reference in their entireties.

### STATEMENT REGARDING FEDERALLY SPONSORED RESEARCH OR DEVELOPMENT

This invention was made with government support under Subcontract Nos. HR00111720030 and W31P4Q-19-C-0052 awarded by the Defense Advanced Research Projects Agency. The government has certain rights in the invention.

### BACKGROUND

Engineering analysis and design systems may include one or more computing devices or systems that implement mathematical modeling, simulation, and analysis techniques for solving problems and/or evaluating design options that arise or are part of engineering tasks and projects. Non-limiting examples of such systems include computer-aided design (CAD) and computer-aided manufacturing (CAM) systems. Implementation may take the form of machine-language instructions, such as programming code, that translate mathematical equations and analyses into computational algorithms.

### SUMMARY

The complexity of both the mathematics involved and the algorithms that implement engineering analysis and design systems, as well as the engineering problems to which they are applied, can present challenges to computational speed and efficiency, even for fast and powerful state-of-the-art computing systems. Consequently, analytic and algorithmic techniques that can produce complex computational results rapidly and efficiently and without consumption of undue computing resources can offer real material and practical advantages over possible alternative approaches that do not achieve comparable computational performance.

One aspect of analysis that arises in many engineering problems is rapid evaluation of physical properties via simulation. A fundamental computational operation involved in many types of simulation is volume integration, which refers not only to calculation of the space contained within a volumetric region, but integration of various mathematical functions over the volumetric region. The wide variety of problems in which volume integration is performed, and the diversity of geometric representations of real and virtual objects and entities over which integration may need to be carried out, makes the analytic and algorithmic challenge one not only of computational speed and efficiency, but of interoperability as well. That is, having to devise a distinct approach, or needing to incorporate custom manual steps for each of a diverse class of problems, can be a significant impediment to the overall performance of an engineering analysis and design system. Even solutions that offer limited interoperability are typically only semi-automated and require manual intervention. As such, these solutions do not scale well when applied to increasingly larger and more complex problems, resulting in significant costs.

The inventors have recognized that integration of a function over a geometrically described region provides an integral measure over the region of properties represented by the function. As is known, mathematically, the geometrically described region specifies a “domain,” and the integral of a function over the domain provides a quantitative measure of the shape of the set of points contained in the domain, referred to as a “moment.” The inventors have further recognized that the mathematical formulation of moments represents a quantitative description of the geometry of a domain that is independent from the particular form of the domain's geometric representation within any particular class of shape-description formalisms. For example, shapes or volumes represented by meshes, stacked images, G-code, or skeletons, to name a few, can, in principle, all be described by a moment that, once determined, is no longer tied to the representational formalism. As such, moments can serve as a sort of vehicle for interoperability between computational integration techniques and a wide variety of diverse geometric representations. The inventors have still further recognized that, in a practical sense, this algorithmic interoperability can form the basis for interoperability of integral computation in and between engineering analysis and design systems.

The inventors have also recognized the use of moments in volume integration techniques may be generalized and extended to other areas of analysis, besides solid modeling for engineering applications or other more traditional fields of engineering. For example, the techniques may be applied to medical imaging scans and procedural representations. Thus, engineering systems, such as CAD, CAM, and computer-aided engineering (CAE) systems, are just examples of the types of computing systems in which moment-based computations may be employed.

Accordingly, the inventors have devised a new framework for analysis which uses moments as the unifying link between geometry and physics. Example techniques presented herein are based on two fundamental insights of the inventors: 1) that analysis for any physics generally requires integral properties of the geometry such as the stiffness and mass matrix, and 2) that the moments of a domain are sufficient to ensure accurate integration of a large class of integrands. Starting from these insights, it may be shown that moments can be computed directly from the geometry for a diverse set of geometric representations without requiring representation conversions such as meshing or full evaluation of geometry for implicit representations. Example embodiments herein provide a system for interoperable analysis that has compositional semantics, computational efficiency, and practical applicability.

As described below, moment-vectors can also form the basis for novel query in query-based analysis methods for interoperable analysis. It may be demonstrated that querying integral properties can improve computational and compositional properties over non-integral queries such as point membership classification (PMC).

Thus, in one respect, example embodiments may involve a method for computing integrals over geometric domains, the method comprising: at a first computing device, receiving data comprising a geometric representation of an object, the geometric representation specifying a geometric domain corresponding to a shape and a contained spatial region of the object; at the first computing device, computationally integrating a predetermined set of basis functions over the geometric domain to derive a moment-vector for the object, the moment-vector encapsulating an analytic formulation of the geometric domain that is independent of the geometric representation of the object; at the first computing device, computationally generating quadrature rules for integrating an arbitrary function by applying moment-fitting to the moment-vector; providing the quadrature rules to a second computing device; and at the second computing device, independently of the geometric representation of the object, computationally integrating the arbitrary function over the geometric domain by applying the quadrature rules.

In another respect, example embodiments may involve a system for computing integrals over geometric domains, the system comprising: a first computing device comprising a first computational analysis system for carrying out operations including calculation of moment-vectors for arbitrary geometric representations of objects; and a second computing device comprising a second computational analysis system for carrying out operations including analysis of physical and/or operational characteristics of simulated objects, wherein the first computational analysis system is configured to: receive data comprising a geometric representation of an object, the geometric representation specifying a geometric domain corresponding to a shape and a contained spatial region of the object; computationally integrate a predetermined set of basis functions over the geometric domain to derive a moment-vector for the object, the moment-vector encapsulating an analytic formulation of the geometric domain that is independent of the geometric representation of the object; computationally generate quadrature rules for integrating an arbitrary function by applying moment-fitting to the moment-vector; and provide the quadrature rules to the second computational analysis system via a common interface for transfer of quadrature rules between the first and second computational analysis systems; and wherein the second computational analysis system is configured to: independently of the geometric representation of the object, computationally integrate the arbitrary function over the geometric domain by applying the quadrature rules.

In still another respect, example embodiments may involve a first-stage computing device comprising: one or more processors; memory, and instructions stored in the memory that, when executed by the one or more processors, cause the first-stage computing device to carry out operations including: receiving data comprising a geometric representation of an object, the geometric representation specifying a geometric domain corresponding to a shape and a contained spatial region of the object; computationally integrating a predetermined set of basis functions over the geometric domain to derive a moment-vector for the object, the moment-vector encapsulating an analytic formulation of the geometric domain that is independent of the geometric representation of the object; computationally generating quadrature rules for integrating an arbitrary function by applying moment-fitting to the moment-vector; and providing the moment-vector to a second-stage computing device; wherein the second-stage computing device is configured to: independently of the geometric representation of the object, computationally integrate the arbitrary function over the geometric domain by applying the quadrature rules.

In yet a further respect, example embodiments may involve a second-stage computing device comprising: one or more processors; memory, and instructions stored in the memory that, when executed by the one or more processors, cause the second-stage computing device to carry out operations including: receiving, from a first-stage computing device, quadrature rules for integrating an arbitrary function over a geometric domain corresponding to a shape and a contained spatial region of an object, wherein the geometric domain is specified according to a geometric representation of the object; and independently of the geometric representation of the object, computationally integrating the arbitrary function over the geometric domain by applying the quadrature rules; wherein the quadrature rules are computed by the first-stage computing device, the first-stage computing device being configured to: receive data comprising the geometric representation of the object; computationally integrate a predetermined set of basis functions over the geometric domain to derive the moment-vector for the object, the moment-vector encapsulating an analytic formulation of the geometric domain that is independent of the geometric representation of the object; computationally generate the quadrature rules for integrating the arbitrary function by applying moment-fitting to the moment-vector; and provide the moment-vector to the second-stage computing device.

In yet one more respect, example embodiments may involve a non-transitory computer-readable medium having instructions stored thereon that, when executed by the one or more processors of a system for computing integrals over geometric domains, cause the system to carry out operations including: receiving, at a first computing device, data comprising a geometric representation of an object, the geometric representation defining a geometric domain descriptive of a shape and a contained spatial region of the object; at the first computing device, computationally integrating a predetermined set of basis functions over the geometric domain to derive a moment-vector for the object, the moment-vector encapsulating an analytic description of the geometric domain that is independent of the geometric representation of the object; at the the computing device, computationally generating quadrature rules for integrating an arbitrary function by applying moment-fitting to the moment-vector; providing the quadrature rules to a second computing device; and at the second computing device, independently of the geometric representation of the object, computationally integrating the arbitrary function over the geometric domain by applying the quadrature rules.

In still one further respect, example embodiments may involve a method for computing integrals over geometric domains, the method comprising: at a first computing device, receiving data comprising a geometric representation and a field representation of an object, the geometric representation specifying a geometric domain corresponding to a shape and a contained spatial region of the object, and the field representation specifying a spatially varying physical quantity within the geometric domain; at the first computing device, computationally integrating a predetermined set of basis functions over the geometric domain multiplied by respective field values at integration points to derive a moment-vector for the object, the moment-vector encapsulating an analytic formulation of the geometric domain and an associated field that is independent of the geometric representation and the field representation of the object; at the first computing device, computationally generating quadrature rules for integrating an arbitrary function by applying moment-fitting to the moment-vector, wherein the quadrature rules incorporate quadrature weights that account for the associated field; providing the quadrature rules to a second computing device; and at the second computing device, independently of the geometric representation and the field representation of the object, computationally integrating the arbitrary function over the geometric domain by applying the quadrature rules.

In yet one further respect, example embodiments may involve a system for computing integrals over geometric domains, the system comprising: a first computing device comprising a first computational analysis system for carrying out operations including calculation of moment-vectors for arbitrary geometric representations and arbitrary field representations of objects; and a second computing device comprising a second computational analysis system for carrying out operations including analysis of physical and/or operational characteristics of simulated objects, wherein the first computational analysis system is configured to: receive data comprising a geometric representation of an object and a field representation of the object, the geometric representation specifying a geometric domain corresponding to a shape and a contained spatial region of the object, and the field representation specifying a spatially varying physical quantity within the geometric domain; computationally integrate a predetermined set of basis functions over the geometric domain multiplied by respective field values at integration points to derive a moment-vector for the object, the moment-vector encapsulating an analytic formulation of the geometric domain and an associated field that is independent of the geometric representation of the object and the field representation of the object; computationally generate quadrature rules for integrating an arbitrary function by applying moment-fitting to the moment-vector, wherein the quadrature rules incorporate quadrature weights that account for the associated field; and provide the quadrature rules to the second computational analysis system via a common interface for transfer of quadrature rules between the first and second computational analysis systems; and wherein the second computational analysis system is configured to: independently of the geometric representation and the field representation of the object, computationally integrate the arbitrary function over the geometric domain by applying the quadrature rules.

In still another respect, example embodiments may involve a first-stage computing device comprising: one or more processors; memory, and instructions stored in the memory that, when executed by the one or more processors, cause the first-stage computing device to carry out operations including: receiving data comprising a geometric representation and a field representation of an object, the geometric representation specifying a geometric domain corresponding to a shape and a contained spatial region of the object, and the field representation specifying a spatially varying physical quantity within the geometric domain; computationally integrating a predetermined set of basis functions over the geometric domain multiplied by respective field values at integration points to derive a moment-vector for the object, the moment-vector encapsulating an analytic formulation of the geometric domain that is independent of the geometric representation of the object and the field representation of the object; computationally generating quadrature rules for integrating an arbitrary function by applying moment-fitting to the moment-vector, wherein the quadrature rules incorporate quadrature weights that account for the associated field; and providing the moment-vector to a second-stage computing device; wherein the second-stage computing device is configured to: independently of the geometric representation of the object and the field representation of the object, computationally integrate the arbitrary function over the geometric domain by applying the quadrature rules.

In yet an additional respect, example embodiments may involve a second-stage computing device comprising: one or more processors; memory, and instructions stored in the memory that, when executed by the one or more processors, cause the second-stage computing device to carry out operations including: receiving, from a first-stage computing device, quadrature rules for integrating an arbitrary function multiplied by a field representation of an object over a geometric domain corresponding to a shape and a contained spatial region of the object, wherein the geometric domain is specified according to a geometric representation of the object and the field representation comprises a material field expressed analytically as a tensor field specifying a spatially varying physical quantity within the geometric domain; and independently of the geometric representation and the field representation of the object of the object, computationally integrating the arbitrary function over the geometric domain by applying the quadrature rules; wherein the quadrature rules are computed by the first-stage computing device, the first-stage computing device being configured to: receive data comprising the geometric representation and the field representation of the object; computationally integrate a predetermined set of basis functions over the geometric domain multiplied by respective field values at integration points to derive the moment-vector for the object, the moment-vector encapsulating an analytic formulation of the geometric domain that is independent of the geometric representation of the object and the field representation of the object; computationally generate the quadrature rules for integrating the arbitrary function by applying moment-fitting to the moment-vector, wherein the quadrature rules incorporate quadrature weights that account for the associated field; and provide the moment-vector to the second-stage computing device.

In still one additional respect, example embodiments may involve a non-transitory computer-readable medium having instructions stored thereon that, when executed by the one or more processors of a system for computing integrals over geometric domains, cause the system to carry out operations including: receiving, at a first computing device, data comprising a geometric representation and a field representation of an object of an object, the geometric representation defining a geometric domain descriptive of a shape and a contained spatial region of the object, and the field representation specifying a spatially varying physical quantity within the geometric domain; at the first computing device, computationally integrating a predetermined set of basis functions over the geometric domain multiplied by respective field values at integration points to derive a moment-vector for the object, the moment-vector encapsulating an analytic description of the geometric domain and an associated field that is independent of the geometric representation of the object and the field representation of the object; at the computing device, computationally generating quadrature rules for integrating an arbitrary function by applying moment-fitting to the moment-vector, wherein the quadrature rules incorporate quadrature weights that account for the associated field; providing the quadrature rules to a second computing device; and at the second computing device, independently of the geometric representation and the field representation of the object of the object, computationally integrating the arbitrary function over the geometric domain by applying the quadrature rules.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF DRAWINGS

FIG. 1 illustrates four examples of geometric representations of various solids, in accordance with example embodiments.

FIG. 2 is a conceptual illustration moment-based volume integration for various geometric representations, in accordance with example embodiments.

FIG. 3 illustrates an example mesh representation, in accordance with example embodiments.

FIG. 4 depicts an example solid (a statue) and three example representations of the solid, in accordance with example embodiments.

FIG. 5 is a graphical plot showing results of tests and trials of moment-based volume integration techniques, in accordance with example embodiments.

FIG. 6 illustrates analysis of a skeleton lattice L-bracket, displaying the normalized displacement and normalized Von Mises stress, in accordance with example embodiments.

FIG. 7 illustrate analysis on the 3DBenchy model, in accordance with example embodiments.

FIG. 8 illustrates analysis on a computed tomography (CT) scan of a femur head, in accordance with example embodiments.

FIG. 9 depicts examples of stress for uniform and heterogeneous materials, in accordance with example embodiments.

FIG. 10 depicts an example of heterogeneity in a material field, in accordance with example embodiments.

FIG. 11 depicts an example of a layered composite plate, in accordance with example embodiments.

FIG. 12 depicts examples of displacement and deformation in a layered composite plate, in accordance with example embodiments.

FIG. 13 depicts examples of G-code analysis for isotropic and anisotropic material properties, in accordance with example embodiments.

FIG. 14 depicts a simplified block diagram of an example computing device, in accordance with example embodiments.

FIG. 15 depicts a simplified block diagram of an example cloud-based server cluster, in accordance with example embodiments.

FIG. 16 is a flow chart of an example method, in accordance with example embodiments.

FIG. 17 is a flow chart of an example method applied to material fields, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

One of the challenges of solid modeling in science and engineering—in realms of both theory and application, such as manufacturing and process management, for example—is supporting rapid evaluation of physical properties via computer simulations. In practice, there are a diversity of geometric representations that can limit or restrict the feasibility of scaling specialized or “one-off” solutions across an expanding variety of design regimes and tools. This challenge may be viewed as one of interoperability between geometry and analysis.

It should be noted that the term “solid” as used herein does not necessarily imply or require a literal solid object, although such an interpretation is not excluded. In a more general sense, a “solid” may refer to a geometrically bounded region of space that can be characterized descriptively as having a shape, and analytically as being or containing a volume. As such, the customary term “solid” may be a convenient conceptual (if not literal) descriptor for purposes of discussion. However, analytic geometry admits a larger array of representations, from the tangible solid to the more mathematically abstract. Such an array of representations is contemplated herein.

Representations can be fully evaluated or implicit, some are multi-scale, some are based on a manufacturing plan, and some inherit properties from the way the data are acquired. In addition, some recent procedural representations based on unit-cells, texture mapping, and skeletal models, to name a few, have been proposed to model the complex artifacts, which are now possible with newer manufacturing technologies, such as additive manufacturing.

A prevalent method for analysis is to convert these representations into volumetric meshes (such as tetrahedral meshes) and then use a mesh-based finite element method. Generating such a mesh typically requires explicit approximation of the boundary of the domain, which may not be easily available for many representations. Meshing can be challenging even when the boundary is available, and often requires manual pre-processing steps such as removing small features and fixing mesh errors.

Other analysis approaches, such as voxel-based finite-element analysis (FEA), lower dimensional analysis, and isogeometric analysis, may also be available, but, generally, each is applicable to only a single representation of the domain. Mesh-free analysis approaches aim to solve these challenges by divorcing the representation of the finite element basis functions from the representation of the geometric domain. This, however, may introduce new challenges in the integration of arbitrary domains and diverse representations.

The challenge, then, of interoperable analysis involves devising a single framework that can work with any geometric data source while retaining the efficiency and expressive power of per-representation solutions. Integration is usually the primary computational bottleneck of analysis, and depends strongly on the geometric representation. As such, the inventors have recognized that interoperable integration plays an important, if not dominant, role in interoperable analysis in general.

Accordingly example embodiments herein are directed to providing computational techniques implemented by a computing system for computing integrals over object volumes in a way that is independent, or at least largely so, of any analytical formalism for describing or specifying the shape or geometric form of the objects. As referred to herein, an “object” can be a physical, solid or tangible entity, or could be a more abstract or conceptual entity that represents a how material is distributed in space and functions and/or procedures that connect them or describe an evolutionary path of the material. For example, G-code may be used to encode a toolpath of a machine in an additive manufacturing process plan.

Other non-limiting examples of shape-describing formalisms include volumetric meshes, voxel-based elements, stacked images, and skeletal models. Each of these, and others not necessarily described herein, provide a form of “language” for encoding descriptions of shapes of real and/or virtual objects or entities. In any particular instance, the formalism adopted may depend on the particular type of problem being solved, the type of engineering system being used to solve it, or both. There may be other considerations as well.

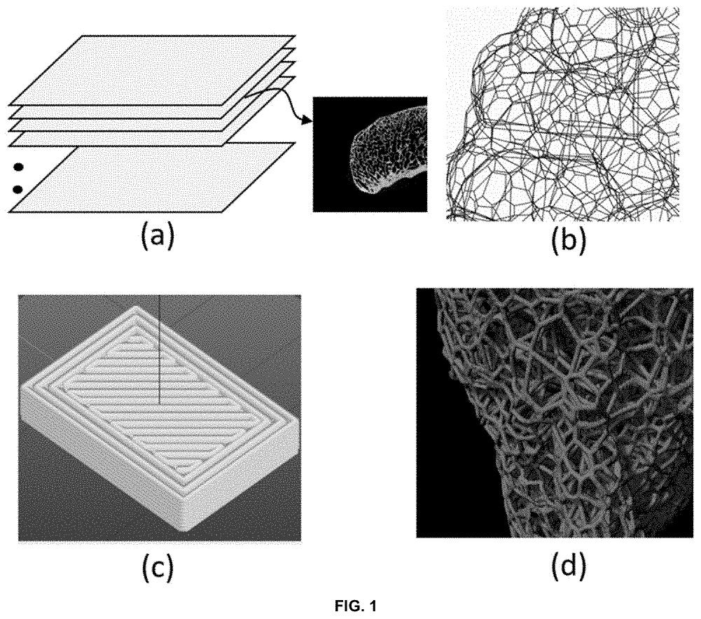

FIG. 1 illustrates just four examples of geometric representations, depicted in four panels. Panel (a) shows stacked images, such as computer tomography (CT) scans; panel (b) shows a section of a skeletal model; panel (c) shows an example of G-code representation; and panel (d) shows a portion of mesh representation. It will be appreciated that there are other geometric representations, and that the moment-based integration methods described herein by way of example may be applied to these as well.

In all instances, however, there may arise a need to calculate an integral of one or more functions over the volume of an object. As outlined above, conventional techniques for doing this are typically tied to the particular formalism used to describe the object shape, in the sense that operations adapted to the specific formalism and applied to the specific object must be carried out in order to compute the volume integral over the object. The operations need to be adapted and carried out anew for any given object and formalism. Thus, conventional techniques do not lend themselves to generalization or interoperability. Further, many of the operations are computationally tedious and/or expensive.

In accordance with example embodiments, the geometric representation of an object, such as a description of the object's shape, can be quantified using one or more moment-vectors that may then be used to compute integrals of arbitrary functions over the object's volume in a manner that is independent of the formalism used to describe the object. As described above, in analytical terms, an object's shape or volume may be specified mathematically as a domain. Thus, integration is carried out over a domain for the object. In an example embodiment, a domain may be discretized into a set of cells, and a moment-vector may be computed for each cell. The mathematical details that underlie derivation and application of the moment-vector technique are described in detail below.

### II. Moment-Based Computation of Integrals

Conventional mesh-based methods generally rely on hard-coded quadrature rules for integration which may be formulated for many different types of elements. In isogeometric analysis, quadrature rules have been further optimized by taking into account that non-uniform rational basis spline (NURBS) bases usually possess a degree of smoothness across element boundaries and are translation invariant. However, both the traditional mesh-based method and the isogeometric method require an evaluated representation of the volume. In the context of conventional mesh-free methods, geometrically adaptive integration using hierarchical subdivision has been widely used for interoperable analysis. However, it can be very computationally expensive for non-trivial geometries which may require excessive subdivision. In contrast, a moment-fitting integration method allows generation of custom quadrature rules for mesh-free elements and has been widely used for surface representations.

Some conventional representation-specific integration techniques in use have been optimized for the assumptions of the representation. For instance, low-dimensional models can be integrated using lower-dimensional quadrature rules. Voxels can be integrated via Gaussian cube quadrature rules. Boundary representations such as meshes and spline surfaces can be integrated via adaptive spatial subdivision or by leveraging the divergence theorem in the case of symbolically-integrable integrands. While the performance for each of these representation-specific methods can be highly optimized, building a finite element system that works directly with multiple representations requires implementing per-representation integration procedures within the analysis code.

Other techniques of analyzing a wide variety of domain representations have also been tried. For example, numerous attempts to analyze CT scan data, and additive manufacturing toolpaths, use homogenization to produce effective material properties which are interpolated over a volumetric mesh. While this may help solve the issue of computing on a variety of data representations, it does so by hiding the burden of integration complexity within an opaque material property database that cannot be extended to other physical phenomena. Another attempted approach, called query-based analysis, works by abstracting the fundamental geometric properties of a domain through queries such as PMC and ray-boundary intersection to allow integration. While this technique can separate the details of representation from the task of integration, the efficiency of the integration algorithm nevertheless suffers due to the large number of queries required for non-trivial geometries.

### A. Moments and Moment Fitting

1. Moment of a Shape

Let Ω be a bounded subset of [symbol] ³ (three-dimensional real vector space) whose indicator function is Riemann-integrable. Note that this definition generalizes the typical solid modeling formulation if regularity of the domain is not assumed, as integrals are not affected by sets of measure zero (0), and any lower-dimensional manifold has measure zero (0). As commonly used in mathematics, a moment is a quantitative measure of the shape of a set of points Ω. In one dimension, the i^{th} moment is given as:

mᵢ=∫_{Ω}xⁱρdΩ, i∈{0,1,2, . . . }, (1)

which can be generalized to three dimensions (x, y, and z) for arbitrary shape Ω as:

M_{i,j,k}=∫_{Ω}xⁱy^{j}z^{k}ρdΩ, i,j,k∈{0,1,2, . . . }. (2)

If ρ represents mass density, then moments are interpreted as classical physical quantities like total mass, center of mass, and rotational inertia. If ρ is the probability density, then moments may be interpreted as total probability, mean, variance and so on. The moment definition can also be generalized from monomials xⁱy^{j}z^{k} to other polynomial bases. From an algebraic point of view, moments are projections (with respect to L² inner product) of p onto a polynomial basis. Herein, moments will be considered with respect to a monomial basis with ρ=1 and the “moment-vector” of order n will be taken to consist of the following moments over the domain Q:

M=[M_{0,0,0},M_{1,0,0}, . . . ,M_{n,0,0},M_{n,1,0}, . . . ,M_{n,n,0},M_{n,n,1}, . . . ,M_{n,n,n}]^{T}. (3)

2. Integration Via Quadrature Rules

Quadrature rules are numerical integration techniques used to approximate the integrals of arbitrary functions. A quadrature rule may be given as:

∫_{Ω}ƒdΩ≈Σᵢ₌₀ⁿwᵢƒ(xᵢ). (4)

A quadrature rule is defined by a set of sample points and their corresponding weights, which are denoted herein as X={x₀, x₁, . . . , xₙ} and W={w₀, w₁, . . . , wₙ}, respectively. Quadrature rules are generally provided for a normalized geometry and can be easily obtained for affine transformations of the normalized geometry.

3. Quadrature from Moments

If the moment-vector M is known for a shape, a technique called “moment-fitting”can be used to obtain quadrature rules to approximately integrate arbitrary functions over that shape. Assuming the arbitrary integrand ƒ can be approximated by a basis {ƒᵢ|i∈1 . . . n} as:

ƒ≈Σᵢ₌₁ⁿcᵢƒᵢ, (5)

then:

∫_{Ω}ƒdΩ≈∫_{Ω}Σᵢ₌₁ⁿcᵢƒᵢdΩ=Σᵢ₌₁ⁿcᵢ∫_{Ω}ƒᵢdΩ. (6)

In accordance with example embodiments, it may be observed out that the coefficients cᵢ need not be known a priori, as minimizing the integration error of each ƒᵢ will in turn minimize the integration error of ƒ by linearity. This leads to a system of equations as follows:

$$A \cdot W = M \\ A = [ \begin{matrix}{f}_{1} ( {x}_{1} ) & {f}_{1} ( {x}_{2} ) & ⋯ & {f}_{1} ( {x}_{q} ) \\ {f}_{2} ( {x}_{1} ) & {f}_{2} ( {x}_{2} ) & ⋯ & {f}_{2} ( {x}_{q} ) \\ ⋮ & ⋮ & ⋱ & ⋮ \\ {f}_{n} ( {x}_{1} ) & {f}_{n} ( {x}_{2} ) & ⋯ & {f}_{n} ( {x}_{q} )\end{matrix} ] , W = [ \begin{matrix}{w}_{1} \\ {w}_{2} \\ ⋮ \\ {w}_{q}\end{matrix} ] , M = [ \begin{matrix}{m}_{1} \\ {m}_{2} \\ ⋮ \\ {m}_{q}\end{matrix} ] , \\ with {m}_{i} = {\int }_{Ω} {f}_{i} d Ω . \qquad ( 7 )$$

In equation (7), {x₁, x₂, . . . x_{q}}=X are the quadrature points, ƒ₁, ƒ₂, . . . , ƒₙ is the polynomial basis (often a monomial basis), A is the matrix of samples of the basis functions at the quadrature points, W is the weight vector, and M is the moment-vector. In principle, given the moment-vector M, optimal points X and weights W can be generated via non-linear optimization. In practice, however, the points X are prescribed, as this results in a linear system of equations. To avoid underdetermined systems, q=n may be chose, and a QR decomposition may be used to solve the least-squares problem.

Standard quadrature rules like the Gaussian and Lobatto rules can be recovered via moment-fitting. Thus, moment-fitting generalizes standard quadrature rules to arbitrary domains and bases.

### B. Moment-Vector Analysis Framework

1. A Moment-Vector Representation of Shape

In the finite element method, the governing physical equations are expressed in their weak forms, which are integral equations. Evaluation of integral quantities may therefore be considered of primary importance in the finite element method, regardless of the particular physical phenomenon being simulated.

Moments are More Fundamental than Quadrature Rules.

Assume that there are two quadrature rules with points X₁ and X₂ and weights W₁ and W₂, respectively, such that

A₁·W₁=A₂·W₂=M, (8)

where M is a moment-vector of order n. It follows that an equivalence class of quadrature rules may be defined using equation (8), where two rules (defined by the pair A and W) are equivalent if their product A·W is the same moment-vector. Therefore M is the more fundamental quantity, since it uniquely determines an equivalence class of quadrature rules that exactly integrate a given set of functions.

Quadrature rules can be generated by prescribing a certain number of points and solving Equation (7). The choice of quadrature points affects the stability of the system of equations and produces different weights, but the right hand side summarizes the fundamental integral properties of the domain.

Volume Integration with Moment-Vectors.

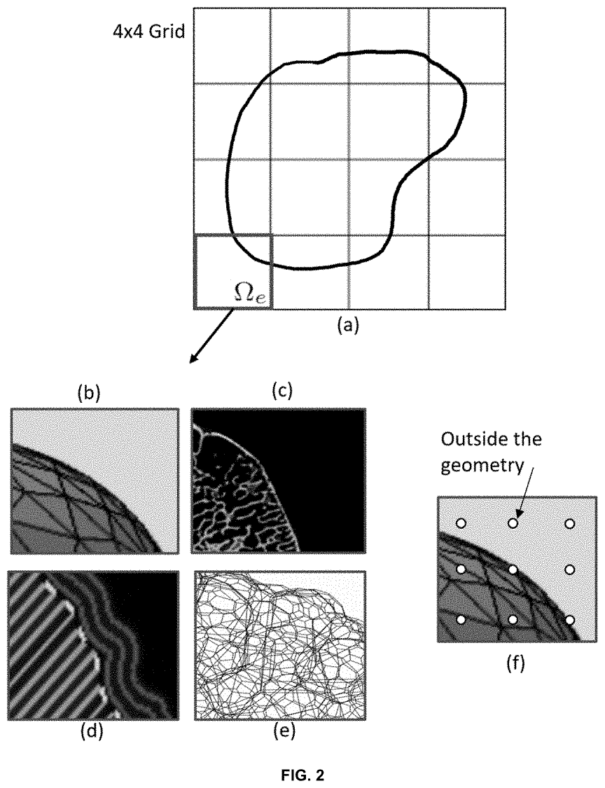

Drawing on the above insights, the inventors have devised an analysis system that performs volume integration using quadrature rules generated on-demand from moment-vectors. In accordance with example embodiments, the system may be implemented using a mesh-free finite element method on a regular grid. This is illustrated panel (a) of FIG. 2. In further accordance with example embodiments, the system also accommodates straightforward extension to other finite element methods as well.

During analysis, the geometry may be reduced to some physical property matrix such as stiffness matrix K, which is further an assembly of element stiffness matrices. The element stiffness, written Kₑ, may be given as an integral,

Kₑ=∫_{Ω}_{ₑ}FₑdΩₑ (9)

where Fₑ is a function of the finite element basis function and constitutive properties, and Ωₑ is the intersection of the domain with a local cell, as illustrated, again, in panel (a) of FIG. 2. If the function F can be reasonably approximated by some polynomial of order n, a quadrature rule that integrates polynomials up to order n is all that is needed. Such a quadrature rule can be generated on demand using the n-th order moment-vector Mₑ of Ωₑ, after which it is only necessary that Ωₑ can integrate the basis functions over the cell. Illustrative examples are shown in panels (b)-(e) of FIG. 2, which depict, respectively, mesh, image, G-code, and skeleton representations within a cell.

2. Compositional Properties

Integrals may be formulated on various Boolean expressions of two domains A and B as follows:

∫_{A∪B}ƒdV=∫_{A}ƒdV+∫_{B}ƒdV−∫_{A∩B}ƒdV (10)

∫_{A-B}ƒdV=∫_{A}ƒdV−∫_{A∩B}ƒdV. (11)

Since moment-vectors are vectors of integrals, they inherit these relations by linearity. Denoting the moment-vector of order n on domain Ω as M(Ω), the relations may then be expressed as follows:

M(A∪B)=M(A)+M(B)−M(A∩B) (12)

M(A−B)=M(A)−M(A∩B). (13)

In particular, if A and B are disjoint as point-sets, then the moment-vector of their union is simply M(A)+M(B). If B⊆A then the moment-vector of their difference is M(A)−M(B). This has implications in the computational properties discussed next.

3. Computational Properties

In terms of moment order n, the worst-case space required to store a moment-vector for a cell is O((n+1)³), since a vector of length (n+1)³ must be stored. This implies that the space usage of moment-vectors is constant for a given downstream integrand order, regardless of model complexity. The number of quadrature points scales similarly due to the moment-fitting equations. In contrast, the number and accuracy of quadrature points used in geometrically adaptive integration is a function of the local geometric complexity and depends strongly on heuristic parameters such as maximum subdivision level.

As discussed above, moment-vectors obey simple laws for composition, so any positive (or negative) change Δ to the domain Ω can be taken into account by adding (or subtracting) the moment-vectors M(Δ) and M(Ω). Furthermore, the locality of the moment-vectors implies that only the cells which overlap the change Δ need to be modified, allowing incremental update of moments in the course of a design process.

In accordance with example embodiments, the cost of computing a moment-vector is incurred just once for a given domain and analysis resolution, and the moments can be reused for any set of boundary conditions or physical phenomena. The cost can be further offset by parallelizing the moment-vector computation, since each cell's moment-vector depends only on local properties.

4. Systems Implications

Moment-based interoperability provides a level of abstraction that may help interface future CAD-CAE systems through the fundamental information that geometry must convey in order to evaluate physics. The term “level of abstraction” in this context should be understood as describing an analytical recasting of differing geometric representations to a common form that may interface with current and future analysis systems. Thus, the “level of abstraction” may effectively make the geometric representation of a solid transparent to a system that analyzes the solid. As demonstrated below, a single analysis code can, in accordance with example embodiments, analyze many representations without knowing anything about the native geometry and without callbacks to the original geometry system as in PMC- or raytracing-based integration techniques. This is particularly advantageous in environments where latency is high, such as the web, since data transfers typically become prohibitively expensive.

In further accordance with example embodiments, interfacing with existing CAD systems can be streamlined using application programming interfaces (APIs), since APIs for integral properties are a standard geometric capability. Previous approaches to query-based integration may entail implementing new integration algorithms in which geometry-query subroutines are invoked during the computation of the integral. However, the moment-vector approach described herein by way of example puts the responsibility of moment-vector computation solely on the representation, and may thus enable leveraging of optimizations only possible within the CAD system. Furthermore, as new representation-specific integration procedures become available (including new representations), these may be automatically inherited by a moment-based system.

In less standard representations, such as CT data or G-code, interfacing with a moment-based system may entail writing an integration procedure to generate moments. Such procedures may often be specific to the assumptions of the datasets and may rely on heuristics to accurately integrate. However, the concerns of representation are separated from the concerns of analysis, so downstream applications need not change to accommodate these assumptions.

5. Accuracy and Numerical Properties

Considerations of numerical accuracy apply mainly to the accuracy of the representation-specific integration (essentially, error in the moments themselves), and to the accuracy of the moment-fitting.

Inaccuracies due to moment computations are typically the main source of error in moment-fitting methods. This may be exacerbated by treating the native geometry as a black box, so if there is inaccuracy in the process of computing the moments there may be no way to recover the lost geometric information a posteriori.

While the actual moment-fitting technique can introduce inaccuracy due to loss of precision in solving the moment-fitting system, quantifying the error is generally straightforward. In accordance with example embodiments, the basis function integrals may be recomputed via the generated quadrature rule, and the results compared with the original computations. In practice, the potential introduction of significant inaccuracies may be avoided or largely mitigated by careful choice of the numerical method. Accordingly, example choices of numerical implementations are outlined below.

6. Implementation Details

In accordance with example embodiments, the location of quadrature points may be prescribed during moment-fitting by using the Gauss-Legendre (GL) distribution for the bounding box of the geometry. Prescribing the quadrature points can ensure that the system of equations exemplified in equations (5)-(7) is linear, while GL distribution can ensure a well-conditioned linear system. The quadrature rule obtained using moments of order n will exactly integrate any polynomial of order n or less. Some of the points may be located outside the geometry for such a distribution, but it is not a problem as long as the integrand is defined at the points. Again, several choices of basis for moment computation may be available, with monomials usually being the most straightforward. The monomial basis, however, may suffer from ill-conditioned A matrices in Equation (7) due to the large difference in L² norm of the basis functions. Other choices for basis are Legendre polynomials and Chebyshev polynomials. By way of example, monomials are used herein, and good conditioning is ensured by scaling with a change of variables.

The advantageous approach devised in accordance with example embodiments may be illustrated with linear stress analysis. It will be appreciated, however, that moments can be used for other physics as well. The relevant implementation details for this illustration are as follows:
1. For each cell, moment-vectors are computed with representation-specific procedures (see further details described below).
2. For each cell, the moment-fitting equation is solved to generate a quadrature rule.
3. Using the generated quadrature rule, the stiffness integrand can be accurately integrated for that cell.
4. The local stiffness is assembled into the global stiffness matrix.
5. The system of algebraic equations formed by the assembly process is solved.
6. The displacement and stress fields are sampled, producing a visualization of the results.

### C. Computing Moments for Different Representations

In this section, a survey of methods for generating moments from native geometry (refer again to FIG. 1) is presented.

1. Boundary Representations

The divergence theorem is widely used for computing moments of boundary representations as it produces accurate results for symbolically-integrable integrands. A volume integral may be converted to surface integration as follows:

∫_{Ω}_{ₑ} div(F)dΩₑ=∫_{Ω}_{ₑ}F·ndδₑ, (14)

where F is some vector-valued function, δₑ is the boundary of the local element geometry Ωₑ, and n is the boundary normal. For the current example case, div(F)=xⁱy^{j}z^{k} is the monomial moment, so a suitable F can be readily constructed. Further, for meshes, the divergence theorem can be applied recursively to convert boundary integration to edge integration and so on.

The current example implementation first trims the full mesh Q to the element and then extracts edges which lie on the element faces. In accordance with example embodiments, surface integration may be performed on the trimmed mesh and line integration may be performed on the extracted edges. Note that, as a symbolic method, the divergence theorem does not involve geometric approximation of the domain, and any errors in the integration will tend to come from: 1) precision issues in intersection of the domain with the cell; and 2) surface and line integration.

2. Implicit and Procedural Representations

Lower Dimensional Representations.

Lower dimensional representations can be of two types: curves with cross-sections (one-dimensional (1D) representations) and surfaces with thicknesses (two-dimensional (2D) representations), which when swept will result in three-dimensional shapes. The moments can be generated by integrating over the lines or surfaces and then weighting the result by the cross-sectional area or thickness for 1D and 2D representations, respectively. Formally, the local element geometry for the current example is simply a set of pairs, that is, Ωₑ={(Cⱼ, Aⱼ)} with j=1, . . . , t, where Cⱼ is a curve or surface and Aⱼ is the corresponding cross-sectional area or thickness. For such an Ωₑ, the moments mᵢ from Equation (7) can be computed as:

$${m}_{i} = {\int }_{{Ω}_{e}} {f}_{i} d {Ω}_{e} = {\sum }_{j = 1}^{t} {\int }_{{C}_{j}} {f}_{i} {A}_{j} d {s}_{j} , \\ = {\sum }_{j = 1}^{t} {A}_{j} {\int }_{{C}_{j}} {f}_{i} d {s}_{j} ( if {A}_{j} is constant ) , \qquad ( 15 )$$

where ∫_{c}_{ⱼ} is a line or surface integral. It may be reasonably assumed that the cross-section or the thickness is considerably smaller than the length-scale of the geometry. Moments for one-dimensional reinforcements, lattice structures, G-code, etc. representations and two-dimensional surface representations for slices, stacks, and composite plies can be computed using Equation (15).

Constructive Solid Geometry (CSG).

CSG models consist of primitives, which are combined with Boolean operations such as union, difference, and intersection. In the case of disjoint point sets, the moments of the primitives can be easily combined via the relations in Equations (12) and (13). In the case of nontrivial intersection, it is possible to leverage the intersection capability present in every CSG system to evaluate the moments.

Replicated Unit Cells.

In unit cell models, a domain consists of copies of repeated unit cells. The unit cell is typically transformed through scaling and rotation as they are tiled (translated) through space. For efficient moment computation, it is advantageous to use the fact that such a domain simply consists of a set of cells that are transformations of a unit cell, that is Ωₑ={Uₜ} with j=1, . . . , t, where Uⱼ=Γⱼ(U) is the unit cell after Γⱼ transformation is applied to U. Since transformation of integrals when a domain is transformed (e.g., rotated and translated) is not straightforward, it is not necessarily easy to transform the moments to get moments of a transformed cell. On the other hand, quadrature rules can be transformed easily under affine transformations. A hybrid approach may be used to obtain moment-vectors for unit cell representations, as explained below.

The quadrature rule for the unit cell may first be computed using the Gaussian rule, if known. Otherwise moment fitting may be used to obtain the point vector X and weight vector W (both of size q). This “unit” quadrature rule may then be composed with the tiling transformations Γⱼs to get the transformed quadrature vector X^{j} and weight vector W^{j}. The moments can be computed using the transformed rule as follows:

mᵢ=∫_{Ω}_{ₑ}ƒᵢdΩₑ=Σⱼ₌₁^{t}∫_{Uj}ƒᵢdUⱼ=Σⱼ₌₁^{t}Σₖ₌₁^{q}ƒ(xₖ^{j})wₖ^{j}, (16)

where xₖ^{j} and wₖ^{j} are elements of transformed vectors X and W, respectively. Note that, in practice, some of the unit cells may not be fully inside an element e. For such a cell Uⱼ, can the moment computation in Equation (16) can be approximated by merely discarding the integration points xₖ^{j} (and the associated weights) which are outside the element e, which is reasonable since unit cells are usually considerably smaller than the geometry.

Voxels.

For voxel models, the moments are computed by integrating over the voxels. The computation becomes extremely easy if the voxels are considerably smaller than the overall length-scale of the geometry, as the moment integrand can be assumed constant within the voxels. It may be assumed that the finite element cells align with voxel boundaries, such that local element geometry is simply a set of voxels Vₜ, that is, Ωₑ=Vₜ with j=1, . . . , t. The moments can be computed as

mᵢ=∫_{Ω}_{ₑ}ƒᵢdΩₑ=Σⱼ₌₁^{t}∫_{V}_{ⱼ}ƒᵢdVⱼ=Σⱼ₌₁^{t}vⱼƒᵢ(pⱼ) (17)

where vⱼ is the volume of Vⱼ and pⱼ is centroid of Vⱼ. This method of moment computation can be used for traditional voxels (uniform size), adaptive voxels (e.g., available open-source data structure and toolkit for high-resolutions volumes, such as OpenVDB), stacks of images (e.g., CT scans), and so on.

### D. Results

This section presents analysis results for different representations using the moment based approach, in accordance with example embodiments.

1. Boundary Mesh

Accuracy and Efficiency Comparison.

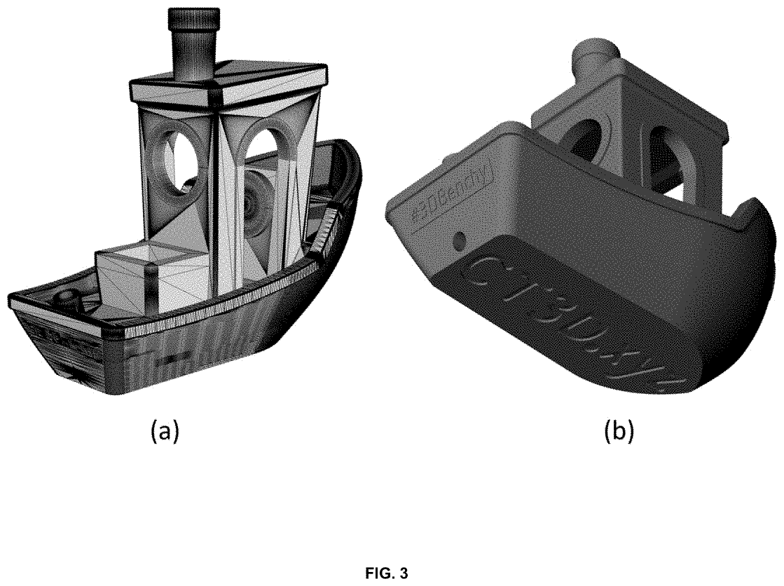

To illustrate a comparison of accuracy, volume may be computed for the known standard 3DBenchy model (FIG. 3), a mesh representation consisting of 137,959 vertices and 225,154 polygons, using the divergence theorem method, described above, with 10,000 mesh-free elements. In particular, the techniques described herein were able to accurately compute volume up to nine (9) significant digits, that is, 15,550.5310 cubic units.

To illustrate efficiency comparison, geometrically adaptive integration was used as the reference. Specifically, implementation was based on a commercial product known as Scan&Solve Pro, and found to be superior to simple adaptivity via the Heaviside function. With 10,000 elements and five (5) subdivisions for the elements at the boundary, Scan&Solve took 495.2 seconds to compute the volume that was accurate to the five (5) significant digits (15,550.4 cubic units). It took 111.8 seconds (99.2 seconds for moment computation and 12.6 seconds for moment fitting) to compute the volume using moments, which is more than four times faster than geometric adaptivity, and accurate to four more significant digits. Both tests were run on a single thread.

Scalability: A Large Mesh.

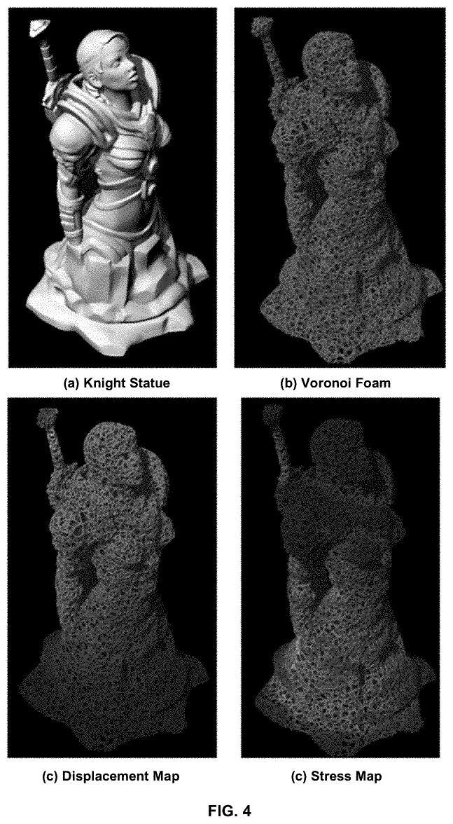

As a demonstration that methods according to example embodiments can scale to demanding models, analysis of a mesh representation of a Voronoi Foam consisting of 8,104,196 vertices and 16,297,996 triangles was carried out. FIG. 4 illustrates, in four panels (a)-(d), a model of a knight statue (panel (a)) and three representations of the model (panels (b)-(d)). Panel (b) depicts the Voronoi Foam representation as generated from the STL mesh of the statue in panel (a). The calculation of moments took about 4,000 seconds to compute on a 36 core cloud instance. As discussed above, the moment-vector can be cached to greatly reduce analysis time of huge models.

Panels (c) and (d) show the normalized displacement map and von Mises stress field map, respectively, assuming the model was fixed at the base and loaded under gravity. It is evident from the relatively darkened top and back portions in the displacement field that the statue is bending towards the back with maximum displacement at the top. Stress is higher nearer the narrower region of the base where the entire weight of the statue has to be supported.

Tolerance to Error: Mesh with Topological and Metric Defects.

Since the technique of computing moments from meshes entails integration over surfaces and edges, rather than the assumption of a solid volume over which to integrate, a further advantage is that the technique may be used to compute moments over imperfect surface meshes. Imperfections over surface meshes are colloquially referred to as “defects,” and may be characterized technically as topological or metric conditions that make the implied enclosed point-set ambiguous or otherwise preclude the use of many traditional integration techniques. By simply integrating over whatever surfaces and edges exist, the technique can thus attain an approximation to the moments of the implied solid form. However, there may still be a question of how the moments degrade as the mesh quality degrades. This may be investigated by considering several types of mesh deformity. Namely, and by way of example: flipped orientation, missing triangles, and offset vertices to produce non-watertight surfaces for a meshed cylinder of radius 5 mm and height 20 mm (5,324 vertices and 10,644 faces). The cylinder may be taken to be under gravity with the bottom face fixed.

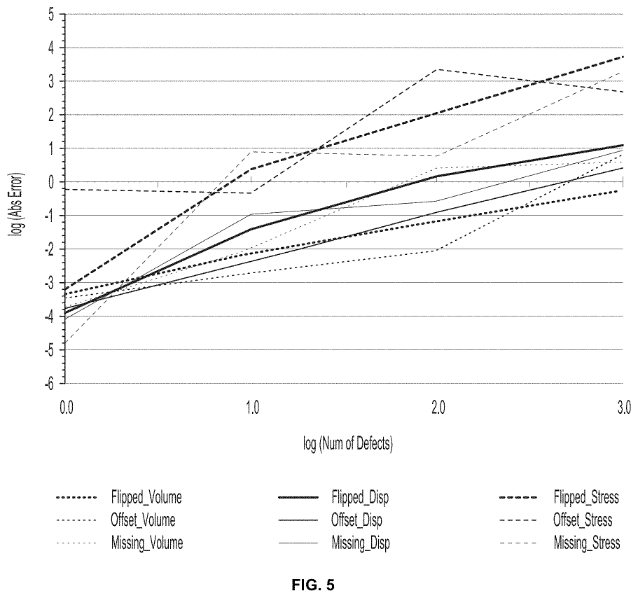

Test and trial applications of example embodiments of moment-based techniques showed graceful degradation of integral properties and downstream simulation fidelity for all three cases of deformity, significant outliers could also be observed. Five runs were performed per combination of defect number and type. For each run, stochastic defects were introduced in the mesh. Results are shown in FIG. 5, which displays the (absolute value) average error in each quantity of interest. The error was computed with respect to the same scenario computed with a cylinder mesh without defects. Note that stress, as a derivative quantity, is particularly susceptible to numerical noise, and thus tends to be much more sensitive to mesh deformities. Most FEA methods are not capable of simulating meshes with any deformities whatsoever, and require manual cleaning and preprocessing steps that modify the input geometry. The solution was sampled on the original mesh, in order to ensure only differences in the solution field itself are measured, rather than differences in the sampling location.

2. Implicit Representations

Skeleton Lattice.

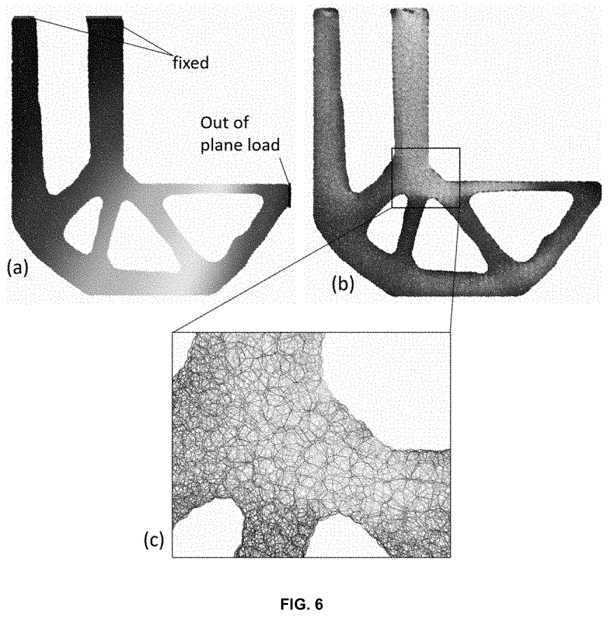

FIG. 6 illustrates analysis of a skeleton lattice L-bracket with 209,371 nodes and 362,522 edges. In the figure, panel (a) shows the normalized displacement, and panel (b) show the normalized Von Mises stress. In accordance with expectation, with the top of the L bracket fixed and a load applied to the right tip, there is a stress concentration near the restraints and the corner of the “L.” Panel (c) in FIG. 6 depicts a detailed (magnified) view showing stresses for the skeleton edges in that corner.

Additive Manufacturing G-Code.

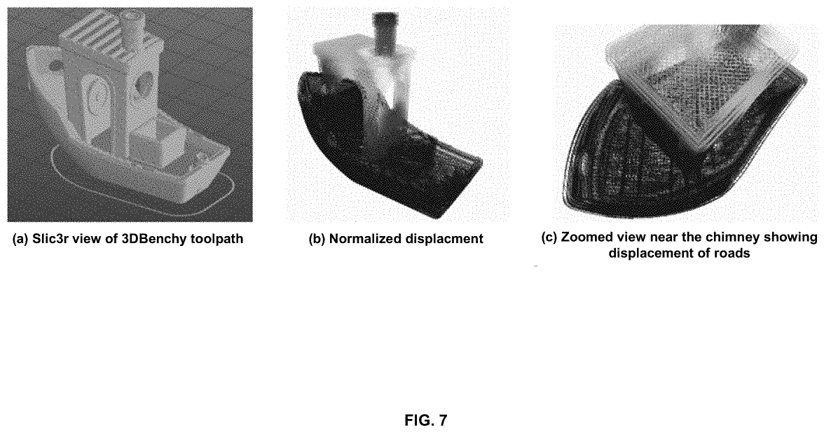

FIGS. 3 and 7 illustrate analysis on the 3DBenchy model is demonstrated by way of example. More particularly, panel (a) of FIG. 3 shows a boat that may be taken to be fixed on the bottom surface with a downward pressure load is applied to the top of the chimney, and panel (b) of FIG. 3 depicts small features. Panel (a) of FIG. 7 shows the toolpath generated from the slicer. The normalized results are shown in panels (b) and (c) of FIG. 7. The solution results in the figures correspond to sampling on the G-code roads to illustrate the varying microstructure pattern throughout the domain.

Image Stack.

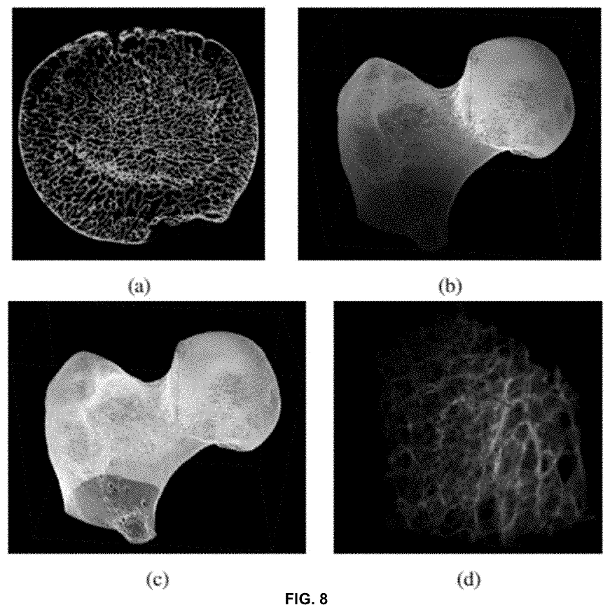

FIG. 8 illustrates analysis on a computed tomography (CT) scan of a femur head, where each pixel in a stack of images defines the domain. The illustrated results demonstrate deployment of an example of the moment generation code on a known available system, Amazon Web Services (AWS) Lambda, computing moments from each image in its own process, where advantage was taken of the parallel nature of the problem. The original dataset was noisy, and the data were minimally preprocessed by thresholding and binarizing the images. The figure includes four panels, (a)-(d). Panel (a) displays a cropped image slice of the femur having an original pixel resolution of 1,033×1,572; the total number of images is 1,286. Panel (d) is a normalized displacement map; panel (c) is a normalized Von Mises map; and panel (d) displays stress rendered for the micro-structure of a small femur section.

By way of example, the bottom cross-section of the femur was assumed to fixed and an upward body load was applied to the whole femur. As noted, the normalized displacement and stress fields are shown in panels (b) and (c), respectively. In this illustration, the highest displacement is seen in the head of the femur as the femur effectively bends about the fixed section. High stress, on the other hand, is seen in the neck of the femur which is a narrower region. Stresses in the microstructure can be seen in panel (d).

### E. Extension to Material Fields

The description above of moment-vectors of geometry may be extended to encompass representations of fields defined over the geometry. As already used herein, at least implicitly, a field, F, may be considered an abstraction of quantities that vary in space. Expressed analytically, F(r)=F(x,y,z), where F can be scalar, vector, or tensor valued. Fields may be used in the representation of design and manufacturing data during analysis.

1. Analytical Formalism

A field of quantities that describe the behavior of material of an object for a given physics may be referred to as a “material field.” Material fields may be scalar-valued fields (e.g., density, and isotropic thermal conductivity), or tensor-valued (e.g., structural stiffness, or anisotropic thermal expansion coefficients).

Recall that, with the generalized three-dimensional moment defined in equation (2) and ρ=1, the moment-vector of order n over the domain Ω could be represented by the expression in equation (3). As noted, ρ can represent a mass density (which may be heterogeneous) or a probability density, for example. However, the simplifying assumption of ρ=1 is not necessarily required, and need not necessarily hold. In particular, when ρ is not identically one, the moments may encode the spatial distribution of the function ρ throughout the domain Ω.

In general, any spatially-variable tensor field may be encoded in moments. Consider, for example, a tensor field T(r) having components

Tₗ^{m},l∈{0,1, . . . ,p}, m−{0,1, . . . ,q}.

For each component of the tensor field, the moments of the (scalar) component may be defined as:

M_{i,j,k}(Tₗ^{m})=∫_{Ω}xⁱy^{j}z^{k}Tₗ^{m}dΩ,i,j,k∈{0,1,2, . . . }. (18)

These moments encode the spatial distribution of each component of the tensor field T(r). With this formalism, the moment-vector for each tensor component Tₗ^{m} may be expressed as:

M(Tₗ^{m})=[M_{0,0,0}(Tₗ^{m}),M_{1,0,0}(Tₗ^{m}), . . . ,M_{n,0,0}(Tₗ^{m}),M_{n,1,0}(Tₗ^{m}) . . . ,M_{n,n,0}(Tₗ^{m}),M_{n,n,1}(Tₗ^{m}), . . . ,M_{n,n,n}(Tₗ^{m})]^{T}. (19)

Once the moments M_{i,j,k}(Tₗ^{m}) of a material field are computed for all i, j, k, l, and m, they can then be used to generate quadrature rules by moment-fitting the moment vector m(Tₗ^{m}) of each component of T(r). This leads to a set of quadrature weights

wₗ^{m},l∈{0,1, . . . ,p}, m∈{0,1, . . . ,q}.

The weights can then be assembled into a tensor-valued quadrature weight W, having components wₗ^{m}. With this formalism, the tensor-valued quadrature weights (one for each quadrature point) may be used to assemble integrals of the form:

∫_{Ω}ƒ(r)T(r)dΩ≈Σᵢ₌₀^{p}ƒ(rᵢ)W(rᵢ). (20)

As is evident, this form represents a function ƒ(r) multiplied by a material field T(r) computed over a geometric domain Ω. As with the discussion of vector-moments above, the formalism can provide a basis for computation of the integral.

Examples of integrals of this form include stiffness matrices in the finite element method (where the material tensor T is of a size 6×6), mass computations (where the material tensor T is of order one (1) and is thus scalar, and integrals of von Mises stress (such as for computing average von Mises stress).

2. Examples of Application to Material Fields

Functionally-Graded Material Field

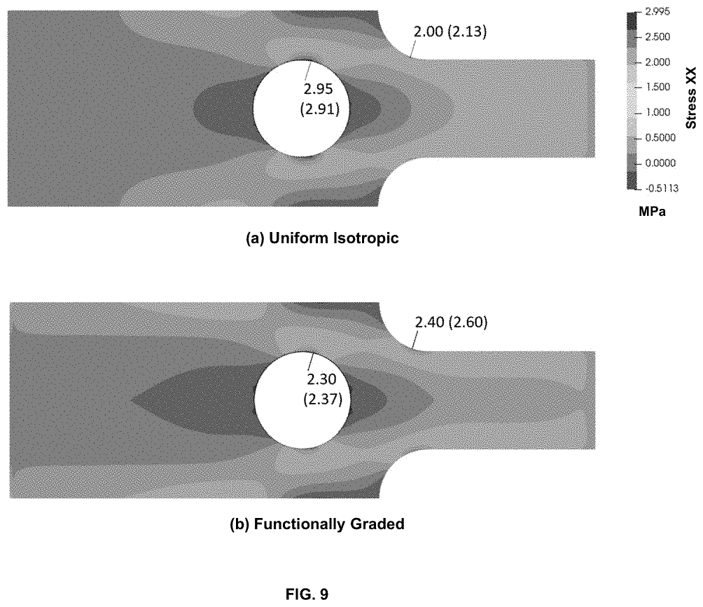

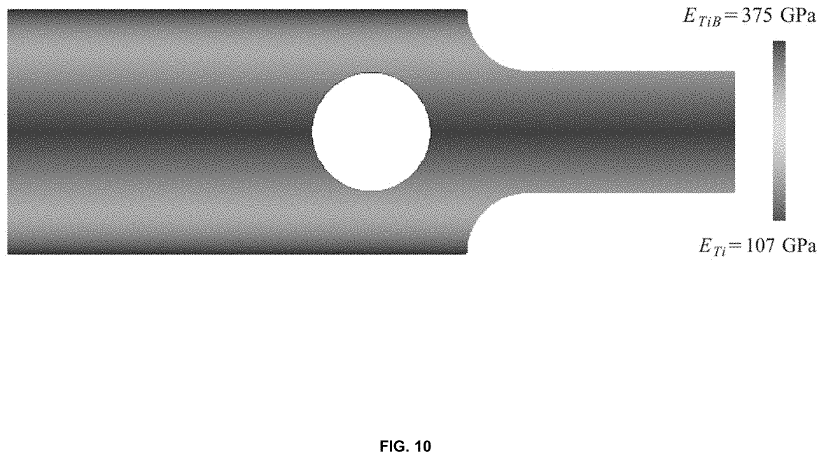

FIG. 9 depicts examples of stress for uniform and heterogeneous materials, in accordance with example embodiments. Specifically, panel (a) on the left shows stress values for linear static stress analysis assuming a uniform isotropic material field; panel (b) on the right shows stress values for linear static stress analysis assuming a functionally-graded (i.e., heterogeneous) material field. FIG. 10 depicts an example of heterogeneity in a material field, in accordance with example embodiments. Comparison of the two panels in FIG. 9 demonstrate significant differences in behavior that are difficult to model without using moments to accurately integrate the material fields.

Layered Composites

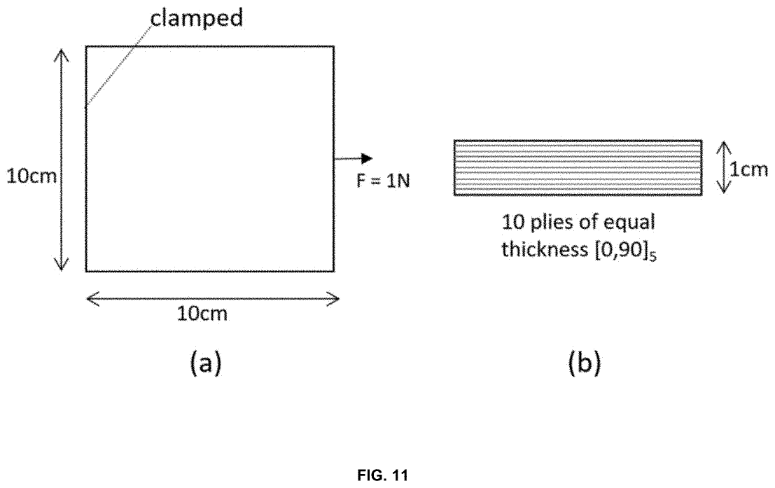

Another example of an application of material field moments is the analysis of (layered) composite materials, as shown in FIG. 11, which an example of a layered composite plate, in accordance with example embodiments. More particularly, panel (a) on the left depicts geometry and boundary conditions; panel (b) on the right shows the ply configuration. Layered composites are made by stacking several thin plies, where the plies are fiber-reinforced. The example composite panel in FIG. 11 is 1 cm thick and made of 10 plies which are 0.1 cm thick. The ply is stiffer in the direction in which the fibers are laid/oriented, which leads to a material field that is fiber direction-dependent and, therefore, anisotropic. In addition, fiber orientation can be varied from ply to ply as demonstrated in FIG. 11, where the adjacent plies alternate between 0 and 90-degree fiber orientation. Effectively, the material field in composites is anisotropic and spatially varying.

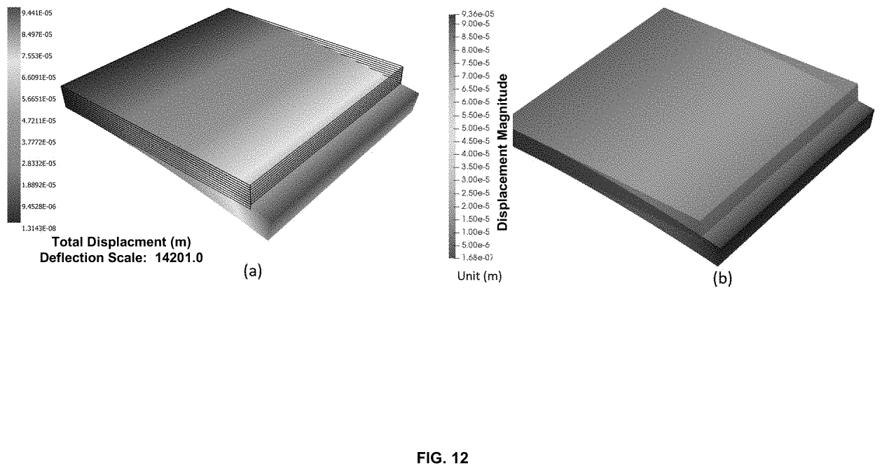

Material moments may be used to represent the complex material field induced by the composite ply layup, where the integration to compute moments is done by integrating over the surfaces that denote the ply in the layup. FIG. 12 depicts examples of displacement and deformation in a layered composite plate, in accordance with example embodiments. More specifically, panel (a) on the left shows result computed by modeling each ply independently as a solid; panel (b) shows results from analysis of the composite panel using material moments. Comparison of results shows good agreement. However, modeling each ply independently is generally extremely computationally expensive, particularly relative to composite modeling using material moments. This demonstrates one of the significant advantages of modeling material fields.

Additive Manufacturing Process Plan (G-Code)

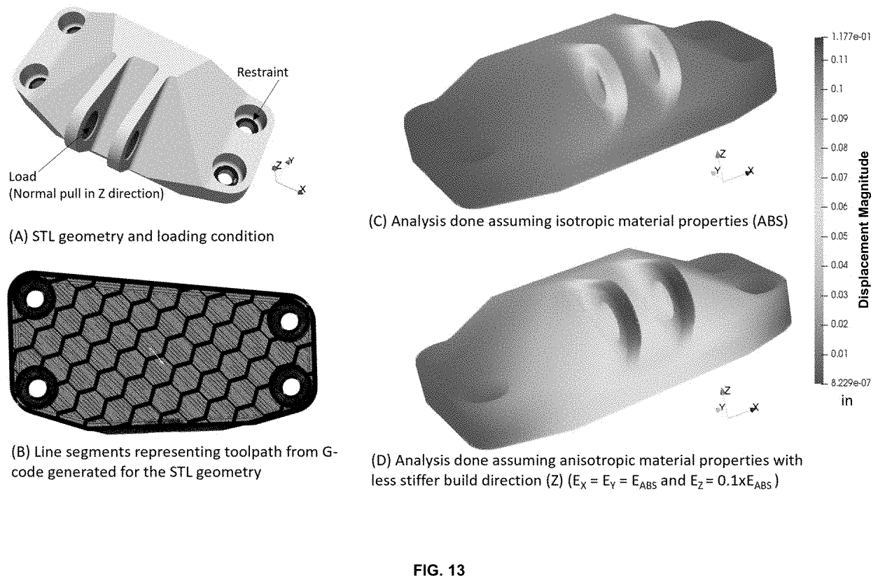

Additive manufacturing (AM), where components are manufactured by depositing material “road by road” and layer by layer, can result in a complex material field in a final printed (manufactured) component. In addition, component interiors can often be partially filled using different infill patterns to save material. As described above, G-code may be used to encode a toolpath of a machine in an additive manufacturing process plan. FIG. 13 depicts examples of G-code analysis for isotropic and anisotropic material properties, in accordance with example embodiments. In particular, panel (B) shows a G-code representation of a part depicted panel (A) with hexagonal infill. Material moments may be used to represent the complex material field induced by the G-code, where the integration to compute moments is done by integrating over the line segments that denote the tool path in the G-code. Panels (C) and (D) show a displacement field when roads are assumed to have isotropic material properties and anisotropic material properties, respectively.

### III. Example Computing Devices and Systems

Example embodiments disclosed herein may be implemented in and/or include computing systems and/or devices and methods carried out by the computing systems and/or devices. Example computing systems and/or devices may include one or more special and/or general purpose processes, volatile and non-volatile storage, including non-transient machine readable media, such as magnetic disk, solid state memory, among others. Systems may also include a user interface, including interactive input devices, such as keyboards, and display devices and graphical user interfaces (GUIs).

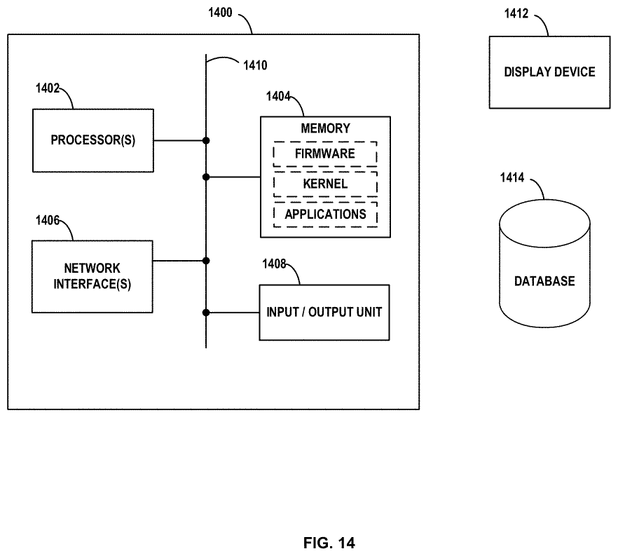

FIG. 14 is a simplified block diagram of an example computing device 1400, according to example embodiments. Computing device 1400 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features. As shown, the computing system 1400 includes processor(s) 1402, memory 1404, network interface(s) 1406, and an input/output unit 1408. By way of example, the components are communicatively connected by a bus 1410. The bus could also provide power from a power supply (not shown). In some embodiments, computing device 100 may include other components and/or peripheral devices (e.g., detachable storage, printers, and so on).

Processor 1402 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 1402 may be one or more single-core processors. In other cases, processor 1402 may be one or more multi-core processors with multiple independent processing units. Processor 1402 may also include register memory for temporarily storing instructions being executed and related data, as well as cache memory for temporarily storing recently-used instructions and data.

Memory 1404 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 1404 represents both main memory units, as well as long-term storage. By way of example, the memory 1404 may include firmware, a kernel, and applications, among other forms and functions of memory. The memory 1404 may store machine-language instructions, such as programming code, that may be executed by the processor(s) 1402 in order to carry out operations that implement the methods and techniques described herein. Memory 1404 may also store data used by these and other programs and applications.

Network interface(s) 1406 may provide network connectivity to the computing system 100, such as to the internet or other public and/or private networks, and may take the form of one or more wireline interfaces, such as Ethernet (e.g., Fast Ethernet, Gigabit Ethernet, and so on). Network interface 1406 may also support communication over one or more non-Ethernet media, such as coaxial cables or power lines, or over wide-area media, such as Synchronous Optical Networking (SONET) or digital subscriber line (DSL) technologies. Network interface 1406 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 1406. Furthermore, network interface 1406 may comprise multiple physical interfaces. For instance, some embodiments of computing device 1400 may include Ethernet, BLUETOOTH®, and Wifi interfaces.

Input/output unit 1408 may facilitate user and peripheral device interaction with example computing device 1400. Input/output unit 1408 may include one or more types of input devices, such as a keyboard, a mouse, a touch screen, and so on. Similarly, input/output unit 1408 may include one or more types of output devices, such as a screen, monitor, printer, and/or one or more light emitting diodes (LEDs). Additionally or alternatively, computing device 1400 may communicate with other devices using a universal serial bus (USB) or high-definition multimedia interface (HDMI) port interface, for example

FIG. 14 also includes a display device 1412 and a database 1414. The display device may be a user client or terminal that includes an interactive display, such as a GUI. It may be used for user access to programs, applications, and data of the computing device 1400. For example, a GUI could be used for graphical rendering of shapes corresponding to objects over which the integration technique is applied.

The database 1414 could include data describing one or more objects over which the integration technique is applied. The data could be in a format corresponding to a particular formalism. Additionally or alternatively, the database could store intermediate and final results of the moment-vector technique. For example, the database could store moment-vectors computed for a library of objects. The database 1414 could be used for other purposes as well.

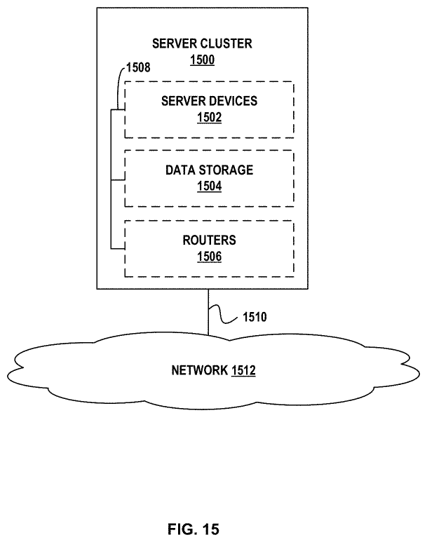

FIG. 15 depicts a cloud-based server cluster 1500 in accordance with example embodiments. In FIG. 1500, operations of a computing device (e.g., computing device 1400) may be distributed between server devices 1502, data storage 1504, and routers 1506, all of which may be connected by local cluster network 1508. The number of server devices 1502, data storages 1504, and routers 1506 in server cluster 1500 may depend on the computing task(s) and/or applications assigned to server cluster 1500.

For example, server devices 1502 can be configured to perform various computing tasks of computing device 1500. Thus, computing tasks can be distributed among one or more of server devices 1502. To the extent that these computing tasks can be performed in parallel, such a distribution of tasks may reduce the total time to complete these tasks and return a result. For purpose of simplicity, both server cluster 1500 and individual server devices 1502 may be referred to as a “server device.” This nomenclature should be understood to imply that one or more distinct server devices, data storage devices, and cluster routers may be involved in server device operations.

Data storage 1504 may be data storage arrays that include drive array controllers configured to manage read and write access to groups of hard disk drives and/or solid state drives. The drive array controllers, alone or in conjunction with server devices 1502, may also be configured to manage backup or redundant copies of the data stored in data storage 1504 to protect against drive failures or other types of failures that prevent one or more of server devices 1502 from accessing units of cluster data storage 1504. Other types of memory aside from drives may be used.

Routers 1506 may include networking equipment configured to provide internal and external communications for server cluster 1500. For example, routers 1506 may include one or more packet-switching and/or routing devices (including switches and/or gateways) configured to provide (i) network communications between server devices 1502 and data storage 1504 via cluster network 1508, and/or (ii) network communications between the server cluster 1500 and other devices via communication link 1510 to network 1512.

Additionally, the configuration of cluster routers 1506 can be based at least in part on the data communication requirements of server devices 1502 and data storage 1504, the latency and throughput of the local cluster network 1508, the latency, throughput, and cost of communication link 1510, and/or other factors that may contribute to the cost, speed, fault-tolerance, resiliency, efficiency and/or other design goals of the system architecture.

As a possible example, data storage 1504 may include any form of database, such as a structured query language (SQL) database. In an example embodiment, data storage 1504 could correspond to one or more instances of database 1414. Various types of data structures may store the information in such a database, including but not limited to tables, arrays, lists, trees, and tuples. Furthermore, any databases in data storage 1504 may be monolithic or distributed across multiple physical devices.

### IV. Example Operation and Methods

Example operation of moment-based integration of arbitrary functions over solids (or more generally, geometric domains) may be illustrated by considering an example implementation for facilitating interoperability between a computer aided design (CAD) system and a computer aided engineering (CAE) system. As is known, a CAD system may be employed to render simulations and representations of an object according to design specifications. Non-limiting examples of an “object” may include a single physical component, a physical system made up of many components, or a manufacturing process having multiple steps and stages. As is also known, a CAE system may be employed to analyze physical and operational characteristics of an object under design through simulation of the object subject to (simulated) physical and/or operational conditions. In practice, the design output of a CAD system may be provided as input to a CAE system, which in turn may “test” the design in simulation in a (possibly iterative) process of refinement and verification. This generalized and high-level description is not intended to be complete or definitive, but rather intended only to set a context for a type of interaction between CAD and CAE systems that, in conventional operation, is well-known to be cumbersome at best, and more typically tedious and difficult.

More specifically, in example operation, a CAD system may obtain or create a geometric representation of an object, while a CAE system, in the process of simulation with the object, may need to perform an integration of an arbitrary function over the object (or more analytically-stated, over a geometric domain corresponding to the object). Owing to the wide variety of types of geometric representations, as well as the variety of third-party CAD and CAE systems available, design/engineering personnel/users using conventional approaches have largely been forced to resort to manual, heuristic procedures for transferring information needed to support computational integration. In contrast, the moment-base techniques for integration described herein by way of example may be used to replace the manual and brute-force procedures with a common interface having none of conventional impediments.

In accordance with example embodiments, a common interface between a CAD system and a CAE system may operate by receiving a geometric representation of an object. For example, the geometric representation may be received from the CAD system. In another example, the geometric representation may be retrieved from a database. Other possible sources of the geometric representation are possible as well. As described above, the geometric representation may be used to specify a geometric domain of the object. In further accordance with example embodiments, a predetermined set of basis functions may then be integrated over the geometric domain to derive or obtain a moment-vector for the object. Quadrature rules for integrating an arbitrary function over the geometric domain may then be computed by applying moment-fitting to the moment-vector. In an example embodiment, the computation of the quadrature rules may be carried out at runtime upon request from the CAE system. The request may also specify the arbitrary function. Finally, and in accordance with example embodiments, the quadrature rules may serve as set of common variables and/or parameters passed to the CAE system, which may then computationally integrate the arbitrary function over the geometric domain, independently of the geometric representation of the object.

The independence of the computational integration from the geometric representation of the object provides a basis for interfacing any CAD system that creates or obtains geometric representations with any CAE system. This is because, in accordance with example embodiments, any CAE system needs only to have the quadrature rules and the arbitrary function in order to carry out the integration. The CAE system does not need to know anything about the geometric representation, which, as described above, can be any one of a variety of know or future forms. Further, computation of the moment-vector and the quadrature rules may be carried out by a facility of the common interface having access to the geometric representation, the basis functions, and the arbitrary function. Accordingly, the common interface may accommodate any CAD system. In an example embodiment, the computations of the moment-vector and quadrature rules could be stored for lookup at runtime, upon a request from the CAE system. Other arrangements are possible as well.

In accordance with example embodiments, the common interface may be implemented using a “plug-and-play” (PnP) architecture. More particularly, the operations of the common interface, namely accessing geometric representations, computing moment-vectors, generating quadrature rules, information passing to and from CAD and CAE systems, may be encapsulated within a “black box” and hidden from the CAD and CAE systems. At the same time, the PnP aspects allow the common interface to be programmatically incorporated into any CAD and/or CAE system as a PnP module. As such the PnP module may introduce a level of interoperability between CAD and CAE systems not previously available. The moment-based techniques of the present disclosure provide that technical and analytical basis that makes this common interface possible.

Example methods may be implemented as machine language instructions stored one or another form of the computer-readable storage, and accessible by the one or more processors of a computing device and/or system, and that, when executed by the one or more processors cause the computing device and/or system to carry out the various operations and functions of the methods described herein. By way of example, storage for instructions may include a non-transitory computer readable medium. In example operation, the stored instructions may be made accessible to one or more processors of a computing device or system. Execution of the instructions by the one or more processors may then cause the computing device or system to carry various operations of the example method.

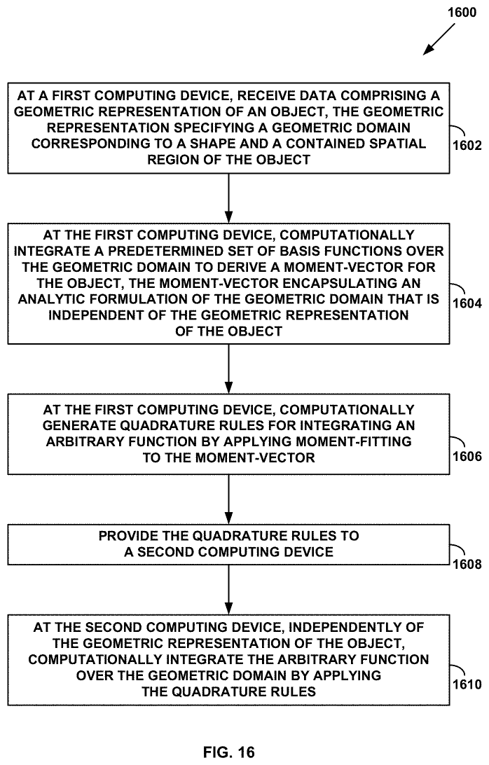

FIG. 16 is a flow chart of an example method 1600, according to example embodiments. As described above, the example method could implemented as machine language instructions stored, for example in the memory 1404, and executed by the processor(s) 1402. By way of example, the method 1600 is described as being carried out by a first computing device and a second computing device. In accordance with example embodiments, the first and second computing devices could be different, or they could be one and the same. The identification as two devices illustrates the aspects of interoperability made possible by the moment-vector approach and techniques described herein. In an example embodiment, a common interface, as described above, could be used in, or to facilitate, a pipeline process.

At step 1602, the first computing device receives data comprising a geometric representation of an object. In accordance with example embodiments, the geometric representation specifies a geometric domain corresponding to a shape and a contained spatial region of the object.

At step 1604, the first computing device computationally integrates a predetermined set of basis functions over the geometric domain to derive a moment-vector for the object. As described above, the moment-vector encapsulates an analytic formulation of the geometric domain that is independent of the geometric representation of the object. In an example embodiment, the basis functions could be polynomials, which could be monomials of the form xⁱy^{j}z^{k}, where i, j, k are integers. Other forms of basis functions could be applied as well, such as rational functions, trigonometric functions, and radial functions, to name a few.

At step 1606, the first computing device computationally generates quadrature rules for integrating an arbitrary function by applying moment-fitting to the moment-vector.

At step 1608, the quadrature rules are provided to the second computing device.

Finally, at step 1610, the second computing device computationally integrates the arbitrary function over the geometric domain by applying the quadrature rules. In accordance with example embodiments, the integration is carried out independently of the geometric representation of the object.

In accordance with example embodiments, the arbitrary function may be approximated by a given set of basis functions. Then, computationally generating the quadrature rules for integrating the arbitrary function by applying moment-fitting to the moment-vector may entail analytically constructing a matrix having as elements the given set of basis functions evaluated at quadrature points of the geometric domain, and computationally solving a matrix equation that equates the moment-vector to the matrix multiplied by a weight vector. In solving the matrix equation, the solution to the matrix equation is the weight vector, and the elements of the weight vector are quadrature weights. Thus, moment-fitting yields the weights for the quadrature rules.

In accordance with example embodiments, computationally integrating the predetermined set of basis functions over the analytical domain to determine the moment-vector for the object could entail integrating the predetermined set of basis functions multiplied by a density field over the analytical domain to determine a density moment-vector for the object.

In accordance with example embodiments, the geometric representation could be a mesh boundary. In this case, computationally integrating the predetermined set of basis functions over the analytical domain may entail iteratively applying the divergence theorem to integration of the predetermined set of basis functions over surfaces, edges, and vertices of the mesh boundary. In further accordance with example embodiments, the mesh boundary could include one or more defects.

In accordance with example embodiments, computationally integrating the predetermined set of basis functions over the analytical domain to determine the moment-vector for the object may entail integrating the predetermined set of basis functions multiplied by a density field over the geometric domain to determine a density moment-vector for the object.

In accordance with example embodiments, the geometric representation could corresponds to image scan data, and the analytical domain could correspond to one or more objects represented by a set of pixels of the image scan data. In this case, computationally integrating the predetermined set of basis functions over the analytical domain to determine the moment-vector for the object may entail integrating the predetermined set of basis functions over the set of pixels of the image scan data.

In accordance with example embodiments, computationally integrating the predetermined set of basis functions over the analytical domain could entail integrating the predetermined set of basis functions over a procedural model or implicit models using transformation rules and known aspects of the procedural model or the implicit model. As a more specific example, an object could be represented by G-code that encodes a toolpath of a machine in an additive manufacturing process plan. In this case, computationally integrating the predetermined set of basis functions over the analytical domain to determine the moment-vector for the object could entail integrating the predetermined set of basis functions over a toolpath.

Also in accordance with example embodiments, computationally integrating the predetermined set of basis functions over the analytical domain to determine the moment-vector for the object could entail precluding subsequent determination of the analytical domain from the determined moment-vector.

In accordance with example embodiments, the example method 1600 could further entail determining one or more additional moment-vectors, each for a respective additional geometric representation of the object, then forming a linear combination of the moment-vector and the one or more additional moment-vectors. Quadrature rules could then be generated by applying moment-fitting to analytically recover the linear combination of the moment-vectors.

In accordance with example embodiments, moments can be used to do multi-scale analysis of multi-scale structures. More specifically, moments may be defined on micro-scale, and then later combined as desired or necessary to carry out macro-scale analysis. The combining of micro-scale moments is possible because of the additive nature of integration. It should be appreciated that the term “micro-scale” as used in this context refers to applying a finer scale analysis to macro-scale objects, or more generally to analysis on multiple, relative size scales.

In accordance with example embodiments, the example method 1600 could further entail storing the moment-vector in a database prior to computationally generating the quadrature rules. Then, computationally generating the quadrature rules for integrating the arbitrary function by applying moment-fitting to the moment-vector could entail retrieving the moment-vector from the database, and applying moment-fitting to the retrieved moment-vector.

In accordance with example embodiments, the first computing device could include or host a first computational analysis system configured to carry out operations including calculation of moment-vectors for arbitrary geometric representations of objects, and the second computing device could include or host a second computational analysis system configured to carry out operations including analysis of physical and/or operational characteristics of simulated objects. With this arrangement, providing the quadrature rules to the second computing device may entail providing the quadrature rules via a common interface for transfer of quadrature rules between the first and second computational analysis systems.

In further accordance with example embodiments under this arrangement, computationally generating the quadrature rules for integrating the arbitrary function by applying moment-fitting to the moment-vector may entail receiving a request at the first computational analysis system, from the second computational analysis system, for the quadrature rules. Further, the request could include information indicating or identifying the arbitrary function, and the first computational analysis system could computationally generate the quadrature rules in response to the request.

In further accordance with example embodiments, providing the moment-vector via the common interface for transfer of quadrature rules between the first and second computational analysis systems may entail transferring the quadrature rules between the first and second computational analysis systems via a plug-and-play (PnP) interface.

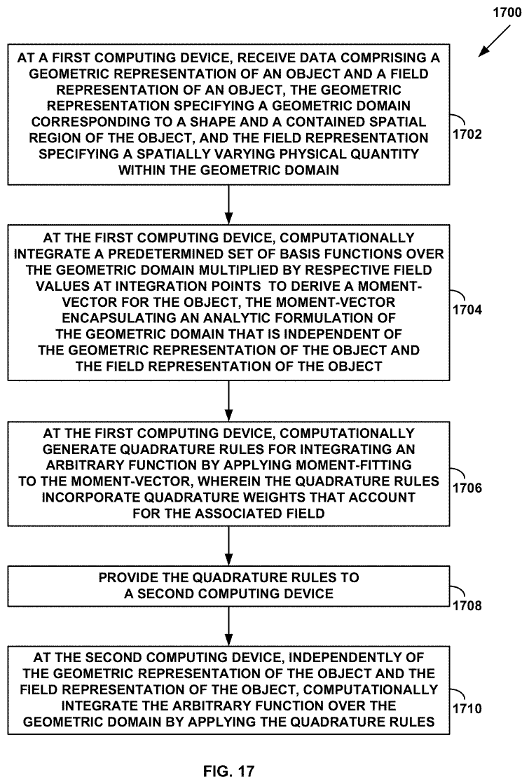

FIG. 17 is a flow chart of an example method 1700 with extension to material fields, according to example embodiments. As described above, the example method could implemented as machine language instructions stored, for example in the memory 1404, and executed by the processor(s) 1402. By way of example, the method 1700 is described as being carried out by a first computing device and a second computing device. In accordance with example embodiments, the first and second computing devices could be different, or they could be one and the same. The identification as two devices illustrates the aspects of interoperability made possible by the moment-vector approach and techniques described herein. In an example embodiment, a common interface, as described above, could be used in, or to facilitate, a pipeline process.

At step 1702, the first computing device receives data comprising a geometric representation and a field representation of an object. In accordance with example embodiments, the geometric representation specifies a geometric domain corresponding to a shape and a contained spatial region of the object, and the field representation specifying a spatially varying physical quantity within the geometric domain.

At step 1704, the first computing device computationally integrates a predetermined set of basis functions over the geometric domain multiplied by respective field values at integration points to derive a moment-vector for the object. As described above, the moment-vector encapsulates an analytic formulation of the geometric domain and an associated field that is independent of the geometric representation and the field representation of the object. In an example embodiment, the basis functions could be polynomials, which could be monomials of the form xⁱy^{j}z^{k}, where i, j, k are integers. Other forms of basis functions could be applied as well, such as rational functions, trigonometric functions, and radial functions, to name a few.

At step 1706, the first computing device computationally generates quadrature rules for integrating an arbitrary function by applying moment-fitting to the moment-vector. In accordance with example embodiments, the quadrature rules incorporate quadrature weights that account for the associated field.

At step 1708, the quadrature rules are provided to the second computing device.

Finally, at step 1710, the second computing device computationally integrates the arbitrary function over the geometric domain by applying the quadrature rules. In accordance with example embodiments, the integration is carried out independently of the geometric representation of the object and of the field representation of the object.

### CONCLUSION

Example embodiments herein demonstrate a novel approach for interoperable analysis that unifies a diverse array of geometric representations via their integral properties, namely the moments. As discussed, moments can provide a level of abstraction that can be leveraged per-representation optimizations, while providing broad applicability, thereby addressing the main challenge of interoperable analysis.

Moment-based analysis systems can be easily integrated with existing geometry frameworks by using APIs for integral properties, which is a standard geometric query. Furthermore, any innovation in native integration procedures will automatically be inherited by a moment-based system.

As described, moments may also be extended to arbitrary density fields. This may open the possibility of applying moment-based analysis to domains that are defined in terms of density fields, such as graded material and probability density. Moment-based methods may thus be extended to analysis of physical properties of anisotropic materials over arbitrary geometric representations and domains. In example embodiments, moment-vectors may be generalized as moment-tensors of vector fields, exotic representations such as probabilistic geometry and density fields, and implementation optimizations allowing for real-time moment computation for interactive simulation on time-varying domains. Operationally, data may be obtained or provided that correspond to a geometric representation of an object of anisotropic composition. A predetermined set of tensor fields may then be integrated over the geometric domain to derive a moment-vector for the object. As with the basis vectors, a moment-vector may thus encapsulate an analytic formulation of the geometric domain that is independent of the geometric representation of the object. Quadrature rules for integrating an arbitrary function by applying moment-fitting to the moment-vector may be generated, and an arbitrary function may be computationally integrated over the geometric domain by applying the quadrature rules, independently of the geometric representation of the object.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method for computing integrals over geometric domains, the method comprising:
at a first computing device, receiving data comprising a geometric representation and a field representation of an object, the geometric representation specifying a geometric domain corresponding to a shape and a contained spatial region of the object, and the field representation specifying a spatially varying physical quantity within the geometric domain;
at the first computing device, computationally integrating a predetermined set of basis functions over the geometric domain multiplied by respective field values at integration points to derive a moment-vector for the object, the moment-vector encapsulating an analytic formulation of the geometric domain and an associated field that is independent of the geometric representation and the field representation of the object;
at the first computing device, computationally generating quadrature rules for integrating an arbitrary function by applying moment-fitting to the moment-vector, wherein the quadrature rules incorporate quadrature weights that account for the associated field;
providing the quadrature rules to a second computing device; and
at the second computing device, independently of the geometric representation and the field representation of the object, computationally integrating the arbitrary function over the geometric domain by applying the quadrature rules.

2. The method of claim 1, wherein the arbitrary function is approximated by a given set of basis functions,
and wherein computationally generating the quadrature rules for integrating the arbitrary function by applying moment-fitting to the moment-vector comprises:
analytically constructing a matrix having as elements the given set of basis functions evaluated at quadrature points of the geometric domain; and
computationally solving a matrix equation that equates the moment-vector to the matrix multiplied by a weight vector, wherein the solution to the matrix equation is the weight vector, and the weight vector comprises the quadrature weights.

3. The method of claim 1, wherein the predetermined set of basis functions comprises a polynomial in dimensions of analytical domain.

4. The method of claim 3, wherein the polynomial is a monomial of a form xⁱy^{j}z^{k}, where i, j, k are integers.

5. The method of claim 1, wherein the field representation comprises a material field expressed analytically as a tensor field,
wherein the geometric representation is a mesh boundary, and wherein computationally integrating the predetermined set of basis functions over the geometric domain multiplied by respective field values at integration points comprises:
iteratively applying the divergence theorem to integration of the predetermined set of basis functions, multiplied by the tensor field, over surfaces, edges, and vertices of the mesh boundary.

6. The method of claim 5, wherein the mesh boundary includes one or more defects.

7. The method of claim 1, wherein the field representation comprises a material field expressed analytically as a tensor field,
wherein computationally integrating the predetermined set of basis functions over the geometric domain multiplied by respective field values at integration points to derive the moment-vector for the object comprises:
integrating the predetermined set of basis functions multiplied by the tensor field over the geometric domain to determine a density moment-vector for the object.

8. The method of claim 1, wherein the field representation comprises a material field expressed analytically as a tensor field,
wherein the geometric representation corresponds to image scan data, and the geometric domain corresponds to one or more objects represented by a set of pixels of the image scan data,
and wherein computationally integrating the predetermined set of basis functions over the geometric domain multiplied by respective field values at integration points to derive the moment-vector for the object comprises:
integrating the predetermined set of basis functions, multiplied by the tensor field, over the set of pixels of the image scan data.

9. The method of claim 1, wherein the field representation comprises a material field expressed analytically as a tensor field,
wherein the geometric representation corresponds to at least one of G-code, or two-dimensional plies in a composite layup,
and wherein computationally integrating the predetermined set of basis functions over the geometric domain multiplied by respective field values at integration points to derive the moment-vector for the object comprises:
integrating the predetermined set of basis functions, multiplied by the tensor field, over at least one of a toolpath defined by the G-code, or over the two-dimensional plies.

10. The method of claim 1, wherein the field representation comprises a material field expressed analytically as a tensor field,
wherein computationally integrating the predetermined set of basis functions over the geometric domain multiplied by respective field values at integration points comprises:
integrating the predetermined set of basis functions, multiplied by the tensor field, over a procedural model or implicit models using transformation rules and known aspects of the procedural model or the implicit model.

11. The method of claim 1, wherein computationally integrating the predetermined set of basis functions over the geometric domain multiplied by respective field values at integration points to derive the moment-vector for the object precludes subsequent analytical determination of the geometric domain from the derived moment-vector.

12. The method of claim 1, further comprising:
determining one or more additional moment-vectors, each for a respective additional geometric representation of the object;
forming a linear combination of the moment-vector and the one or more additional moment-vectors; and
generating quadrature rules by applying moment-fitting to analytically recover the linear combination of the moment-vectors.

13. The method of claim 1, further comprising storing the moment-vector in a database prior to computationally generating the quadrature rules,
and wherein computationally generating the quadrature rules for integrating the arbitrary function by applying moment-fitting to the moment-vector comprises:
retrieving the moment-vector from the database; and
applying moment-fitting to the retrieved moment-vector.

14. The method of claim 1, wherein the second computing device is either: (i) the same as the first computing device, or (ii) different from the first computing device.

15. The method of claim 1, wherein the first computing device comprises a first computational analysis system configured to carry out operations including calculation of moment-vectors for arbitrary geometric representations of objects,
wherein the second computing device comprises a second computational analysis system configured to carry out operations including analysis of physical and/or operational characteristics of simulated objects,
and wherein providing the quadrature rules to the second computing device comprises providing the quadrature rules via a common interface for transfer of quadrature rules between the first and second computational analysis systems.

16. The method of claim 15, wherein computationally generating the quadrature rules for integrating the arbitrary function by applying moment-fitting to the moment-vector comprises:
at the first computational analysis system, receiving a request from the second computational analysis system for the quadrature rules, the request including information indicating the arbitrary function; and
at the first computational analysis system, computationally generating the quadrature rules in response to the request.

17. The method of claim 15, wherein providing the moment-vector via the common interface for transfer of quadrature rules between the first and second computational analysis systems comprises transferring the quadrature rules between the first and second computational analysis systems via a plug-and-play (PnP) interface.

18. A system for computing integrals over geometric domains, the system comprising:
a first computing device comprising a first computational analysis system for carrying out operations including calculation of moment-vectors for arbitrary geometric representations and arbitrary field representations of objects; and
a second computing device comprising a second computational analysis system for carrying out operations including analysis of physical and/or operational characteristics of simulated objects,
wherein the first computational analysis system is configured to:
receive data comprising a geometric representation of an object and a field representation of the object, the geometric representation specifying a geometric domain corresponding to a shape and a contained spatial region of the object, and the field representation specifying a spatially varying physical quantity within the geometric domain;
computationally integrate a predetermined set of basis functions over the geometric domain multiplied by respective field values at integration points to derive a moment-vector for the object, the moment-vector encapsulating an analytic formulation of the geometric domain and an associated field that is independent of the geometric representation of the object and the field representation of the object;
computationally generate quadrature rules for integrating an arbitrary function by applying moment-fitting to the moment-vector, wherein the quadrature rules incorporate quadrature weights that account for the associated field; and
provide the quadrature rules to the second computational analysis system via a common interface for transfer of quadrature rules between the first and second computational analysis systems;
and wherein the second computational analysis system is configured to:
independently of the geometric representation and the field representation of the object, computationally integrate the arbitrary function over the geometric domain by applying the quadrature rules.

19. A first-stage computing device comprising:
one or more processors;
memory,
and instructions stored in the memory that, when executed by the one or more processors, cause the first-stage computing device to carry out operations including:
receiving data comprising a geometric representation and a field representation of an object, the geometric representation specifying a geometric domain corresponding to a shape and a contained spatial region of the object, and the field representation specifying a spatially varying physical quantity within the geometric domain;
computationally integrating a predetermined set of basis functions over the geometric domain multiplied by respective field values at integration points to derive a moment-vector for the object, the moment-vector encapsulating an analytic formulation of the geometric domain that is independent of the geometric representation of the object and the field representation of the object;
computationally generating quadrature rules for integrating an arbitrary function by applying moment-fitting to the moment-vector, wherein the quadrature rules incorporate quadrature weights that account for the associated field; and
providing the moment-vector to a second-stage computing device;
wherein the second-stage computing device is configured to:
independently of the geometric representation of the object and the field representation of the object, computationally integrate the arbitrary function over the geometric domain by applying the quadrature rules.

20. A second-stage computing device comprising:
one or more processors;
memory,
and instructions stored in the memory that, when executed by the one or more processors, cause the second-stage computing device to carry out operations including:
receiving, from a first-stage computing device, quadrature rules for integrating an arbitrary function multiplied by a field representation of an object over a geometric domain corresponding to a shape and a contained spatial region of the object, wherein the geometric domain is specified according to a geometric representation of the object and the field representation comprises a material field expressed analytically as a tensor field specifying a spatially varying physical quantity within the geometric domain; and
independently of the geometric representation and the field representation of the object, computationally integrating the arbitrary function over the geometric domain by applying the quadrature rules;
wherein the quadrature rules are computed by the first-stage computing device, the first-stage computing device being configured to:
receive data comprising the geometric representation and the field representation of the object;
computationally integrate a predetermined set of basis functions over the geometric domain multiplied by respective field values at integration points to derive the moment-vector for the object, the moment-vector encapsulating an analytic formulation of the geometric domain that is independent of the geometric representation of the object and the field representation of the object;
computationally generate the quadrature rules for integrating the arbitrary function by applying moment-fitting to the moment-vector, wherein the quadrature rules incorporate quadrature weights that account for the associated field; and
provide the moment-vector to the second-stage computing device.

21. A non-transitory computer-readable medium having instructions stored thereon that, when executed by the one or more processors of a system for computing integrals over geometric domains, cause the system to carry out operations including:
receiving, at a first computing device, data comprising a geometric representation and a field representation of an object of an object, the geometric representation defining a geometric domain descriptive of a shape and a contained spatial region of the object, and the field representation specifying a spatially varying physical quantity within the geometric domain;
at the first computing device, computationally integrating a predetermined set of basis functions over the geometric domain multiplied by respective field values at integration points to derive a moment-vector for the object, the moment-vector encapsulating an analytic description of the geometric domain and an associated field that is independent of the geometric representation of the object and the field representation of the object;
at the computing device, computationally generating quadrature rules for integrating an arbitrary function by applying moment-fitting to the moment-vector, wherein the quadrature rules incorporate quadrature weights that account for the associated field;
providing the quadrature rules to a second computing device; and
at the second computing device, independently of the geometric representation and the field representation of the object, computationally integrating the arbitrary function over the geometric domain by applying the quadrature rules.
